(19) United States
(12) Patent Application Publication
(10) Pub. No.: US 2011/0226892 A1
(43) Pub. Date: Sep. 22, 2011

(54) ROTARY WING VEHICLE

(76) Inventors: William Crowther, Manchester (GB); Matthew Pilmoor, Manchester (GB); Alexander Lanzon, Stockport (GB); Philip Geoghegan, Bromley (GB)

(21) Appl. No.: 13/057,931

(22) PCT Filed: Aug. 10, 2009
(86) PCT No.: PCT/GB09/50998

§ 371 Date: Jun. 2, 2011

(30) Foreign Application Priority Data
Aug. 8, 2008 (GB) 0814421.4

(51) Int. Cl. B64C 27/08

(52) U.S. Cl. 244/17.23

(57) ABSTRACT

Embodiments of the invention relate to a vehicle comprising a plurality of inclined rotors that are operable to provide at least one of thrust and torque vectoring according to a desired thrust and/or torque vectors.

### FIELD OF THE INVENTION

Embodiments of the invention relate to a vehicle and, more particularly, to a rotary wing vehicle.

### BACKGROUND TO THE INVENTION

A helicopter generates lift using a rotor system. A rotor system comprises a mast, a hub and rotor blades. The mast is coupled to a transmission and bears the hub at its upper end. The rotor blades are connected to the hub. Helicopters are classified according to how the rotor blades are connected and move relative to the hub. There are three basic classifications for the main rotor system of a helicopter, which are rigid, semi-rigid and fully articulated.

Typically, a helicopter has four flight control inputs, which are the cyclic, the collective, the anti-torque pedals, and the throttle. The cyclic control varies the pitch of the rotor blades cyclically, which tilts the rotor disc formed by the rotor blades in operation in a particular direction resulting in movement of the helicopter in that direction. For example, moving the cyclic forward tilts the rotor disc forwards, providing a force in the forward direction and also, more significantly, a moment that pitches the helicopter nose down such that a greater component of rotor thrust is pointed in the direction of travel. Moving the cyclic sidewards tilts the rotor disc in that direction, which, in a similar manner, moves the helicopter sidewards. The collective pitch control, or collective, controls the pitch of the rotor blades collectively and independently of their angular position. Changing the collective results in a change in the overall thrust force of the rotor, which may be used to vary the helicopter altitude or perform other maneuvers requiring an acceleration input. The anti-torque pedals control the yaw of the helicopter. Helicopter rotors are designed to operate at a specific RPM, which is, in turn, controlled by the throttle. The throttle controls the power produced by the engine, which is connected to the rotor system by the transmission. The throttle is used to ensure that the engine produces sufficient power to maintain the rotor RPM within an allowable envelope to maintain flight.

A helicopter has two basic flight conditions; namely, hover and forward flight. To hover, the cyclic is used to provide control forces within a horizontal plane; that is a plane normal to gravity, and the collective is used to maintain altitude. The torque-pedals are used to point the helicopter in a desired direction. A helicopter's flight controls act similarly to those of a fixed-wing aircraft during forward flight. Pushing the cyclic forwards causes the helicopter nose to pitch downwards, which, in turn, increases airspeed and reduces altitude. Moving the cyclic aft, causes the nose to pitch upwards, slows down the helicopter and causes it to climb. Increasing collective power while maintaining a constant airspeed induces a climb while decreasing collective power causes a descent. Coordinating these two inputs, down collective plus aft cyclic or up collective plus forward cyclic, results in airspeed changes while maintaining a constant altitude. The pedals serve the same function in both a helicopter and a fixed-wing aircraft, to maintain balanced flight.

Indeed, in general, to translate a generic air vehicle in an Earth fixed reference frame (Earth axes) when the vehicle does not have thrust vectoring capability, that is, the force vector is substantially fixed with respect to the body, it is necessary to orientate the force vector in the direction of the required acceleration through a change in body attitude. This couples rotational dynamics within a translation control loop, which, in turn, leads to increased control complexity and an increased response time. Furthermore, if the helicopter bears a directional sensor such as, for example, a camera, that is used to track a particular activity in the Earth reference frame, then it is necessary to introduce a potentially heavy and complex gimballing system such that changes in vehicle attitude during maneuvering can be compensated for. The need for such a gimballing system is demonstrated in the following.

Assume x_{b} is three element vector providing the position in Earth axes, or reference axes, of the origin of a set of body axes of a vehicle body and xₜ is the location of a target in earth axes. The required direction vector xₚ to point the x axis of the sensor-fixed axes towards the target is given by

Xₚ=xₜ−x_{b}.

The required orientation of the sensor is given by aligning the sensor x axis with xₚ and rotating the sensor y axis (sensor horizontal reference direction) to be normal to the local gravity vector g. Given that zₚ is orthogonal to xₚ and yₚ, yₚ and zₚ are given by

yₚ=g×xₚ and zₚ=xₚ×yₚ

giving the required sensor orientation matrix, in Earth axes, as

$${R}_{ts} = [ \frac{{\underline{x}}_{p}}{‖ {\underline{x}}_{p} ‖} \frac{{\underline{y}}_{p}}{‖ {\underline{y}}_{p} ‖} \frac{{\underline{z}}_{p}}{‖ {\underline{z}}_{p} ‖} ]$$

The sensor will be in general orientated at some attitude, R_{bs}, with respect to the body axes such that the body attitude R_{tb} in Earth axes to point the sensor at the target is given by:

Rₜₛ=R_{tb}R_{bs} [symbol] R_{tb}=RₜₛR_{bs}^{T}

For a conventional helicopter or fixed wing aircraft R_{tb} is determined by the need to point the thrust (or lift) vector for control of acceleration and, therefore, cannot generally be used to point a sensor while flying an arbitrary trajectory. Therefore, varying sensor orientation must be achieved by varying R_{bs} via a gimbal. It will be appreciated that gimbals add significant weight, complexity and cost to sensor systems such that they are typically only cost effective on larger vehicles with high value sensors.

It is an object of embodiments of the present invention to at least mitigate one or more of the problems of the prior art.

### SUMMARY OF THE INVENTION

Accordingly, an embodiment of the present invention provides a rotary wing vehicle comprising a plurality of rotors for rotation in at least three respective rotation planes wherein said at least three rotation planes are inclined relative to one another.

An embodiment of the present invention provides a vehicle comprising a plurality of powered thrust devices, preferably, rotors, capable of operating, preferably, rotating in respective planes to provide lift and torque for maneuvering the vehicle during flight whereby the planes are inclined relative to one another at non-zero angles.

Advantageously, embodiments of the present invention allow full or partial authority thrust vectoring and full authority torque vectoring, where full authority refers to the ability to point a vector in any direction in three dimensional space and partial authority refers to the ability to point a vector over a limited range of directions in three dimensional space. It is understood that any practical flight vehicle that moves in three dimensions must have at least partial authority torque vectoring in order to arbitrarily orientate the vehicle with respect to the Earth fixed reference frame and/or the relative wind vector. Hence, the existence of partial authority torque vectoring capability is understood to be a necessary condition for controllable flight vehicles. In practice, partial or full authority torque vectoring can be achieved by various established means and its use is widespread. In contrast, full authority or partial authority thrust vectoring is not a necessary condition for controlled flight, however for some flight applications it is of significant benefit where it is advantageous to arbitrarily orientate the body with respect to the vehicle acceleration vector, e.g. for super maneuverability fighter aircraft or for aircraft carrying directional sensors that have to be pointed at targets in the Earth fixed reference frame. Full or partial authority thrust vectoring cannot usually be achieved without significant engineering cost. However, for embodiments of the present invention, by selecting the thrusts of the plurality of rotors, a net or resultant thrust vector can be realised in arbitrarily selectable directions with respect to the vehicle body, thus enabling advantageous decoupling of the vehicle acceleration vector from the vehicle attitude, as already described, at relatively low engineering cost in terms of reduced mechanical complexity.

In preferred embodiments, the powered thrust devices are rotors. Preferably, there are at least 6 such rotors. More preferably, there are 6 rotors. A further embodiment of the present invention provides a ground-mode of locomotion. Suitably, an embodiment comprises a frame disposed outwardly of the rotors; the frame forming a single circular rim that acts as a wheel, or a number of intersecting circular rims of the same diameter that constitute a spherical shell.

It can be appreciated that decoupling translation and rotational control allows a simpler and faster translation control response to be realised as compared to that achievable by vehicles that do not have thrust and torque vectoring capability. A further advantage of embodiments of the invention is that at least one of independent thrust and torque vectoring coupled with a suitable vehicle frame or body makes vehicle translation along a surface possible, including pressing the vehicle against an inclined surface such as, for example, a wall. The latter has the advantage that hovering with reduced thrust (and hence power consumption) can be realised due to frictional coupling with the surface.

Embodiments of the present invention enable R_{tb} to vary independently since a required acceleration vector can be achieved using thrust vectoring, which means that no gimballing is required thereby providing significant advantages to embodiments of the invention.

Embodiments of the invention are able to provide vehicles with at least one of thrust and torque vectoring concurrently with providing sufficient thrust to accelerate the vehicle with an acceleration magnitude of at least g ms⁻², where g is the acceleration due to gravity, such that weight support and maneuvering is possible.

### BRIEF DESCRIPTION OF THE DRAWINGS

Embodiments of the invention will now be described by way of example only with reference to the accompanying drawings in which:

FIG. 1 shows an embodiment of a vehicle according to the present invention;

FIG. 2 illustrates a vehicle reference plane together with rotor disc planes;

FIG. 3 depicts an orthographic view of vehicle body/force and torque axes;

FIG. 4 shows a number of views of prior art rotary wing vehicles;

FIG. 5 illustrates an embodiment of a vehicle according to the present invention;

FIG. 6 depicts a further embodiment of a vehicle according to the present invention;

FIG. 7 shows a still further embodiment of a vehicle according to the present invention;

FIG. 8 is a graph showing the variation of force and moment characteristic axes with varying disc or rotor plane angle;

FIG. 9 illustrates the variation in force and torque characteristic axes with varying disc plane angle for a six rotor face centred planar embodiment;

FIG. 10 depicts the variation in force and torque characteristic axes with varying disc plane angle for a six rotor face centred non-planar embodiment;

FIG. 11 shows the variation in force and torque characteristic axes with varying disc plane angle for a six rotor edge centred non-planar embodiment;

FIG. 12 illustrates an embodiment of a vehicle according to the present invention bearing a frame for rolling;

FIG. 13 depicts an embodiment of a vehicle with an undercarriage;

FIG. 14 shows a further embodiment of a vehicle according to the present invention comprising an undercarriage;

FIG. 15 illustrates earth and body axes;

FIG. 16 depicts torques and forces associated with an embodiment;

FIG. 17 shows characteristic differential torque vectors;

FIG. 18 illustrates a force envelope according to an embodiment;

FIG. 19 shows a control system for a vehicle according to an embodiment;

FIG. 20 depicts a control system for a vehicle according to an embodiment;

FIGS. 21(a) and (b) show embodiments having a ground mode of locomotion;

FIG. 22 illustrates a control and communication system according to an embodiment;

FIG. 23 depicts various arrangements of the rotors for embodiments of the present invention;

FIG. 24 shows the definition of a generic wheel with initial body axes aligned with the Earth axes;

FIG. 25 illustrates steps to correctly synthesize attitude demand for a rolling vehicle;

FIG. 26 depicts superposition of the three rotation states illustrated in FIG. 25;

FIG. 27 shows an embodiment of a modular airframe;

FIG. 28 illustrates of an embodiment of an airframe in assembled and disassembled states;

FIG. 29 depicts an embodiment of a foldable airframe;

FIG. 30 shows an embodiment of a foldable airframe.

### DETAILED DESCRIPTION OF EMBODIMENTS

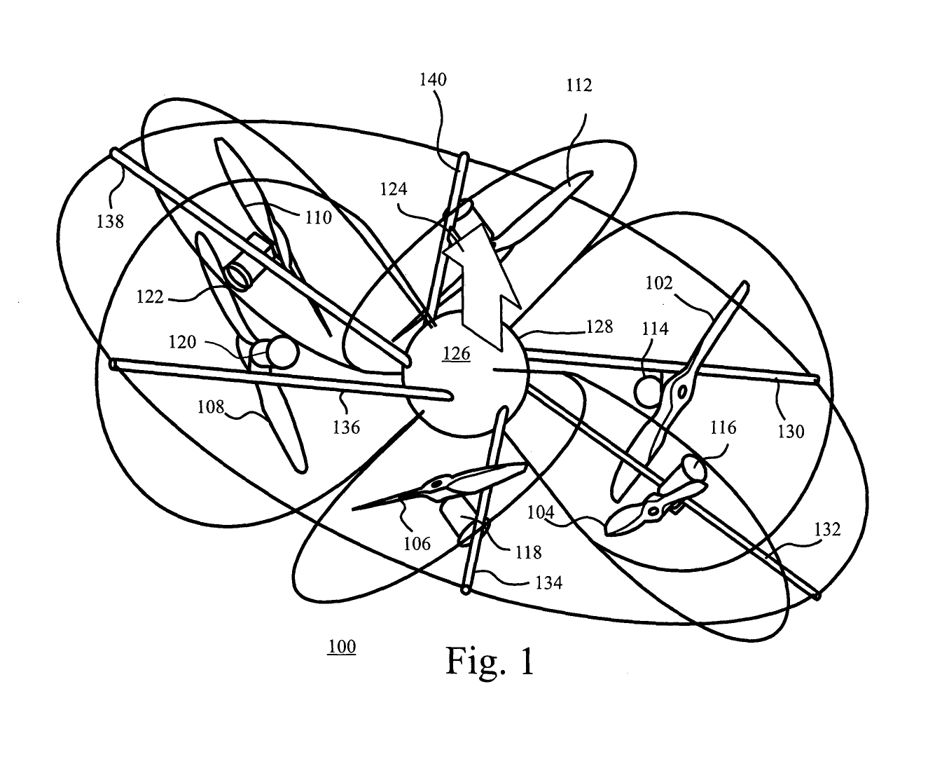

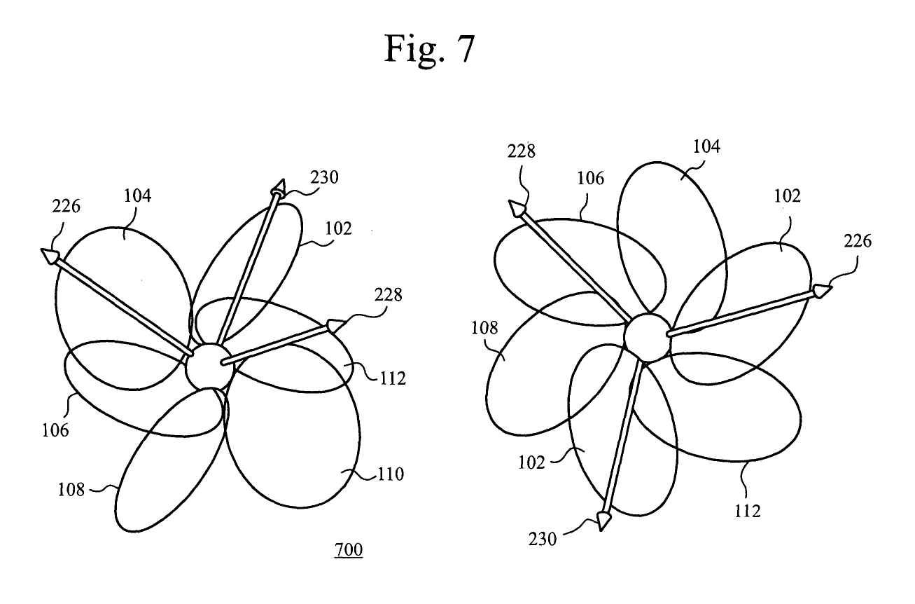

FIG. 1 shows a rotary wing vehicle 100 according to an embodiment of the invention. The vehicle comprises six rotors 102 to 112. The six rotors 102 to 112 are arranged in pairs in three inclined planes (not shown), referred to as disc planes. For the example shown here, the disc planes are orthogonal to each other, however note that the angle between disc planes may be chosen arbitrarily. The rotors 102 to 112 are driven by respective motors 114 to 124. The rotor-motor combinations have a fixed orientation relative to the body 126, or body axes, of the vehicle 100. Therefore, each rotor 102 to 112 provides a respective thrust vector having a fixed orientation relative to a plane (not shown) of the vehicle that comprises the centres of rotation of the rotors 102 to 112. The plane is known as the Vehicle Reference Plane (VRP), which is shown in FIG. 7. The vehicle body 126 comprises a central hub 128 bearing a number of spokes or struts 130 to 140. The rotor-motor arrangements are mounted to the struts 130 to 140.

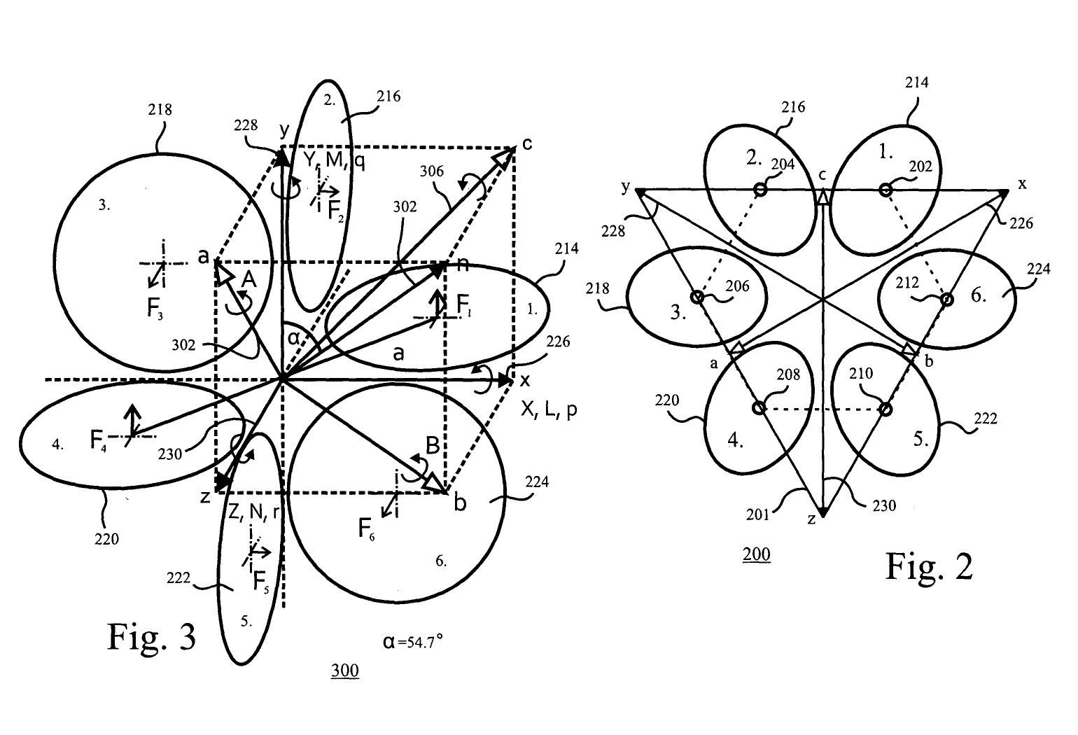

FIG. 2 shows a normal view 200 relative to the vehicle reference plane 201. The vehicle reference plane 201 passes through the centres 202 to 212 of the rotors (not shown). FIG. 2 also illustrates planar discs 214 to 224 that schematically depict rotation planes of the rotors, that is, the rotor discs. Also illustrated are the xyz characteristic axes 226 to 230 of the vehicle 100.

FIG. 3 shows an orthographic view 300 illustrating the relative orientations of the xyz characteristic axes 226 to 230 with respect to the rotor disc planes 214 to 224 for a configuration with orthogonal disc planes. The body axes reference frame for the vehicle is an orthogonal axes system having an origin at the centre of the vehicle. For the special case of orthogonal disc planes, the vehicle xyz characteristic axes are coincident with the xyz body axes and these axes systems are equivalent. It can be appreciated that the multi-rotor vehicle involves a complex three dimensional arrangement of rotors. To define the arrangements of the rotors a general theoretical frame work for characterising multirotor vehicles will be presented, which will assist in identifying differences between the prior art and the embodiments of the present invention. To aid understanding of the principles, the following example considers vehicles with mutually orthogonal rotor disc planes, however, it should be noted that the same principles apply to cases where the rotor disc planes are non orthogonal.

Consider a general multirotor helicopter in which the positions and orientations of m rotor discs with respect to the vehicle body axes are given by a 3 by m matrix, Xᵣ, of position vectors, \hat{x}ᵢ, i=1:m, and a 3 by m matrix, Nᵣ, of rotor normal vectors, nᵢ=1:m. Assume each rotor spins with an angular velocity, ωᵢ, with positive angular velocity defined as clockwise about the positive disc normal. Each rotor provides a force in the rotor normal direction with a magnitude that can be varied by either changing the angle of attack of the blades or by changing the rate of rotation, or a combination thereof, and the force can be positive or negative. Assume that the rotors do not have cyclic control of blade angle of attack and hence the orientation of the rotor normal cannot be varied. Rotor forces produce a torque about the vehicle origin associated with the cross product of the rotor force and a respective position vector, xᵢ, of a respective disc. Each rotor also produces an aerodynamic reaction torque, τᵢ about its axis of rotation (disc normal) with a sign opposite to that of the direction of rotation. The vehicle also experiences a torque, J\dot{ω}ᵢ, associated with the time rate of change of angular momentum of each disc. The force and torque vectors obtained from a single rotor or fan may thus be defined as, respectively,

Fᵢ=nᵢ×Fᵢ (1.1)

and

Tᵢ=nᵢτᵢ+xᵢ×Fᵢ+nᵢJᵢ\dot{ω}ᵢ. (1.2)

Note that for economy of notation, the cross product term in (1.2) is written in terms of non-unitised vectors but could have clearly been expressed in terms of nᵢ. However, it is implicit that the cross product “x” is evaluated using unit vectors, nᵢ with appropriate scaling.

The generalised expressions for force and torque for a multi-rotor vehicle can then be written down as

F=Nᵣf (1.3)

and

T=Nᵣ(τ+J\dot{ω})+(Xᵣ×Nᵣ)f (1.4)

where

$$\underline{f} = [ \begin{matrix}{F}_{1} \\ {F}_{2} \\ ⋮ \\ {F}_{m}\end{matrix} ] , \underline{τ} = [ \begin{matrix}{τ}_{1} \\ {τ}_{2} \\ ⋮ \\ {τ}_{m}\end{matrix} ] , J = [ \begin{matrix}{J}_{1} & 0 & 0 & 0 \\ 0 & {J}_{2} & 0 & 0 \\ 0 & 0 & ⋱ & 0 \\ 0 & 0 & 0 & {J}_{m}\end{matrix} ] , and \\ \underline{ω} = [ \begin{matrix}{ω}_{1} \\ {ω}_{2} \\ ⋮ \\ {ω}_{m}\end{matrix} ] \qquad ( 1.5 )$$

and
Xᵣ×Nᵣ is a 3×m matrix and each column corresponds to (xᵢ×nᵢ).

For the purposes of the present invention, equation (1.3) may be understood as an equation that defines the force vectoring capability of the vehicle and equation (1.4) as defining the torque vectoring capability. The force vectoring equation (1.3) relates the force components acting on the vehicle to the orientation of the rotors and the thrust force produced by each rotor. The torque vectoring equation (1.4) is more complex since torques are obtained from three different sources (rotor forces acting on a moment arm, rotor reaction torques, and torques due to rate of change of angular momentum of the rotors). Note that if the rotor orientations are orthogonal, then the available components of force will be orthogonal. However, the components of torque may or may not be orthogonal, depending on the rotor position matrix.

Embodiments of the present invention enable significant performance benefits to be realised relative to conventional helicopters due to the capability for full authority torque vectoring and full (or partial) authority thrust vectoring. Many multirotor configurations exist that enable force and torque vectoring to be achieved on practical embodiments of vehicles according to the present invention.

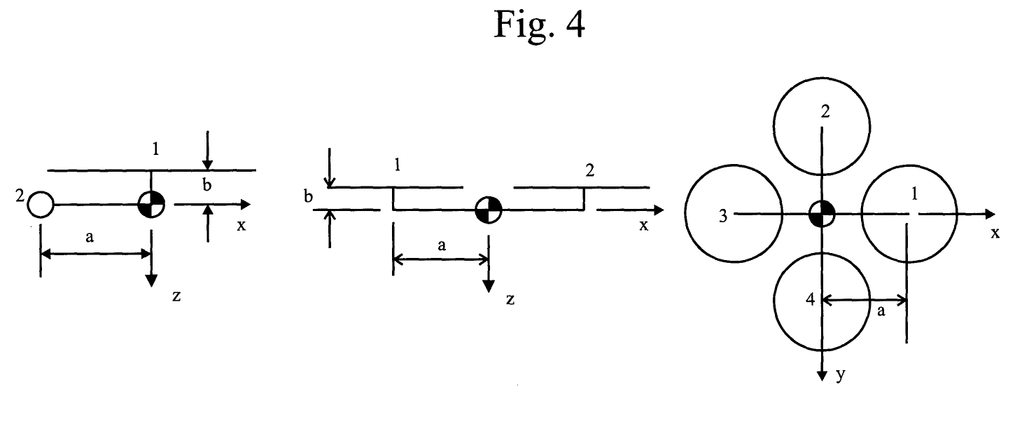

FIG. 4 shows the evolution of known helicopter-like vehicles from a conventional single main rotor helicopter through to a quad-rotor vehicle. They will be used to demonstrate the similarities and differences between existing rotor configurations and embodiments of the present invention in terms of force and/or torque vectoring. The rotor position and orientation matrices, Xᵣ, and Nᵣ, will be stated and the resulting force and torque equations (1.3) and (1.4) will be derived and discussed for each configuration.

### Single Main Rotor Helicopter

Referring to FIG. 4(a), there is shown a conventional helicopter configuration. The rotor position and orientation matrices, given in terms of vehicle body axes, are

$$\begin{matrix}{X}_{r} = [ \begin{matrix}0 & - a \\ 0 & 0 \\ - b & 0\end{matrix} ] and & ( 1.6 ) \\ {N}_{r} = [ \begin{matrix}0 & 0 \\ 0 & 1 \\ - 1 & 0\end{matrix} ] . & ( 1.7 )\end{matrix}$$

Substituting into (1.2) and (1.3) gives

$$\begin{matrix} \underline{F} = [ \begin{matrix}0 & 0 \\ 0 & 1 \\ - 1 & 0\end{matrix} ] [ \begin{matrix}{F}_{1} \\ {F}_{2}\end{matrix} ] = [ \begin{matrix}0 \\ {F}_{2} \\ - {F}_{1}\end{matrix} ] & ( 1.8 ) \\ \underline{T} = [ \begin{matrix}0 & 0 \\ 0 & 1 \\ - 1 & 0\end{matrix} ] ( [ \begin{matrix}{τ}_{1} \\ {τ}_{2}\end{matrix} ] + [ \begin{matrix}{J}_{1} {\dot{ω}}_{1} \\ {J}_{2} {\dot{ω}}_{2}\end{matrix} ] ) + ( [ \begin{matrix}0 & - a \\ 0 & 0 \\ - b & 0\end{matrix} ] \times [ \begin{matrix}0 & 0 \\ 0 & 1 \\ - 1 & 0\end{matrix} ] ) [ \begin{matrix}{F}_{1} \\ {F}_{2}\end{matrix} ] = [ \begin{matrix}0 \\ {τ}_{2} + {J}_{2} {\dot{ω}}_{2} \\ - {τ}_{1} - {J}_{1} {\dot{ω}}_{1} + {aF}_{2}\end{matrix} ] & ( 1.9 )\end{matrix}$$

Equations (1.8) and (1.9) confirm that for the configuration considered, it is possible to vector the force in the yz plane only and that control torque via application of rotor thrust is available about the z axis only. To make a viable flight vehicle it is necessary to provide control moments about all three axes. In practice, this is achieved by using cyclic control on the main rotor, which is a separate type of control strategy to that used by embodiments of the present invention.

For the conventional single main rotor helicopter, the net angular momentum of the rotors is non-zero and this has a significant effect on the vehicle dynamics, introducing significant control challenges. This is in contrast to embodiments of the present invention in which, for embodiments using an even number of rotors, it is possible to arrange the rotor orientations and directions of rotation such that the net angular momentum of the vehicle is nominally zero. Use of a configuration in which the net angular momentum of the rotors is nominally zero is advantageous because gyroscopic effects that make control more complex are eliminated. Therefore, it is assumed that in vehicle configurations according to embodiments of the invention, there is an even number of rotors and the rotor spin directions have been chosen accordingly. Furthermore, for multi-rotor vehicles there are practical advantages in using the same rotor hardware for each of the rotors and thus all the rotors will have nominally the same angular moment of inertia, J.

### Twin Rotor

The rotor position and orientation matrices for a twin rotor vehicle such as is shown schematically in FIG. 4b, are:

$$\begin{matrix}{X}_{r} = [ \begin{matrix}- a & a \\ 0 & 0 \\ - b & - b\end{matrix} ] and & ( 1.10 ) \\ {N}_{r} = [ \begin{matrix}0 & 0 \\ 0 & 0 \\ - 1 & - 1\end{matrix} ] . & ( 1.11 )\end{matrix}$$

and the force and torque equations are

$$\begin{matrix}\underline{F} = [ \begin{matrix}0 \\ 0 \\ - ( {F}_{1} + {F}_{2} )\end{matrix} ] \\ and & ( 1.12 ) \\ \underline{T} = [ \begin{matrix}0 \\ a ( {F}_{2} - {F}_{1} ) \\ - ( {τ}_{1} - {τ}_{2} ) - J ( {\dot{ω}}_{1} + {\dot{ω}}_{2} )\end{matrix} ] & ( 1.13 )\end{matrix}$$

One skilled in the art will notice that the change in orientation of the second rotor of the twin rotor configuration as compared to a conventional helicopter expands the torque vectoring equation, enabling generation of control torques anywhere within the yz plane. Torque control is still missing from the x axis, and in practice, this must be provided by applying cyclic control to the rotors.

### Quad Rotors

Referring to FIG. 4(c), it can be appreciated that the quad rotor is equivalent to two twin rotor vehicles placed on top of each other with the fuselage axes 90 degrees apart. The rotor position and orientation matrices for a conventional planar quad rotor are:

$$\begin{matrix}{X}_{r} = a [ \begin{matrix}1 & 0 & - 1 & 0 \\ 0 & - 1 & 0 & 1 \\ 0 & 0 & 0 & 0\end{matrix} ] & ( 1.14 ) \\ {N}_{r} = [ \begin{matrix}0 & 0 & 0 & 0 \\ 0 & 0 & 0 & 0 \\ - 1 & - 1 & - 1 & - 1\end{matrix} ] & ( 1.15 )\end{matrix}$$

and the force and torque equations are

$$\begin{matrix}\underline{F} = [ \begin{matrix}0 \\ 0 \\ - ( {F}_{1} + {F}_{2} + {F}_{3} + {F}_{4} )\end{matrix} ] \\ and & ( 1.16 ) \\ \underline{T} = [ \begin{matrix}a ( {F}_{2} - {F}_{4} ) \\ a ( {F}_{1} - {F}_{3} ) \\ - ( {τ}_{1} + {τ}_{2} + {τ}_{3} + {τ}_{4} ) - J ( {\dot{ω}}_{1} + {\dot{ω}}_{2} + {\dot{ω}}_{3} + {\dot{ω}}_{4} )\end{matrix} ] & ( 1.17 )\end{matrix}$$

It will be appreciated that for multi-rotor vehicles, the size and, hence, angular moment of inertia of the rotors decreases as compared to single main rotor vehicles. This greatly reduces the inertial component of the torque compared to the reaction component such that (τ₁+τ₂+τ₃+τ₄)>>J(\dot{ω}₁+\dot{ω}₂+\dot{ω}₃+\dot{ω}₄). Furthermore, observing that for a rotor with reasonable aerodynamic efficiency, e.g. a blade lift to drag ratio of at least 10, the torques due to the forces will be significantly larger than the rotor drag torques such that equation (1.17) may be reasonably approximated as

$$\underline{T} = [ \begin{matrix}a ( {F}_{2} - {F}_{4} ) \\ a ( {F}_{1} - {F}_{3} ) \\ - ( {τ}_{1} + {τ}_{2} + {τ}_{3} + {τ}_{4} )\end{matrix} ] \qquad ( 1.18 )$$

From equation (1.17) or 1.18 it can be seen that the quad rotor configuration enables control torques to be generated in all three body axes, enabling full authority attitude control of the vehicle without use of cyclic pitch control on any of the rotors. Note that moments in the xy plane are produced by differential rotor thrust whereas moments about the z axis are produced from differential drag torques. The single component of force in the z direction in the force equation (1.16) results from all of the rotors being in a single plane. The planar quad rotor configuration, therefore, is fully controllable without use of cyclic rotors. However, since the thrust vector is fixed with respect to the body, that is, since there is no thrust vectoring, the body attitude cannot be varied independently of a demand acceleration vector or vice versa.

Next an analysis of embodiments of the present invention will be undertaken for an embodiment having 6 rotors in various configurations to achieve full authority thrust and torque vectoring on a practical flight vehicle.

One skilled in the art will appreciate that for a 6 rotor vehicle there are a large number of ways in which the rotors can be positioned and orientated. It is desirable to use some engineering judgment to identify solutions with the greatest degree of practicality. Firstly, preferred embodiments use paired planar rotors with opposite spin directions to influence, and preferably guarantee, the existence of zero net angular momentum, which is a significant advantage as already described. Therefore, the embodiments described will, in general, have rotors that are so arranged. However, it should be noted that this is not a necessary condition for a successful 6 rotor vehicle in general. Secondly, it is assumed that the three rotor pairs exist on three characteristic planes that pass through the origin of the vehicle axes and whose normals define three equispaced characteristic axes, or basis vectors. If the characteristic planes happen to be orthogonal, these basis vectors form an orthogonal coordinate system centred at the origin and the angle between the basis vectors is 90 degrees. The effect of using non-orthogonal planes will be discussed further later.

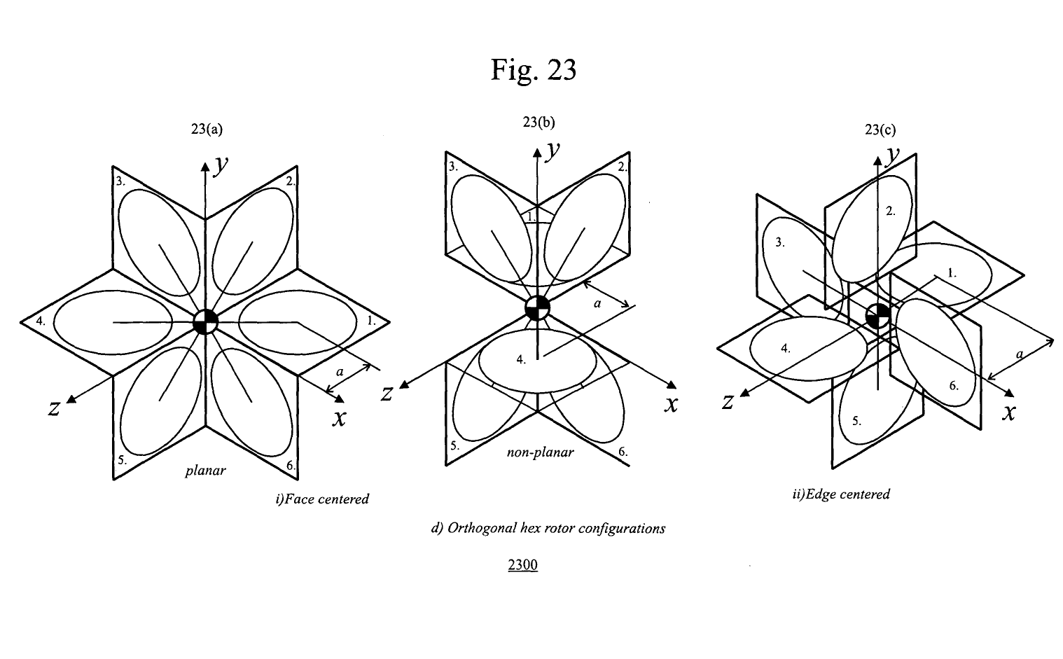

Embodiments of three orthogonal rotor configurations will be considered in greater detail with reference to FIGS. 2, 3, 5, 6, 7 and FIGS. 23(a) to 23(c). Note that the identifiers ‘face centred’ and ‘edge centred’ relate to the way in which the rotor discs are placed within the xyz characteristic axes defined by the intersections of the characteristic planes, and will be discussed further as part of the discussion on the use of non-orthogonal characteristic planes. Referring briefly to FIGS. 23(a) to 23(b), it can be appreciated that the first two embodiments 23(a) and 23(b) are both face centred, but differ in that one, FIG. 23(a), is a planar embodiment and the other, 23(b), is a non-planar embodiment. The centres of rotation of the rotors in FIG. 23(a) are coplanar whereas only the centres of rotation of rotors 2, 3, 5 and 6 are coplanar with the centres of rotation of rotors 1 and 4 being coplanar with one another but lying in their own plane. Note that for the special case of orthogonal characteristic planes, the vehicle characteristic axes are also orthogonal. For the face centred configurations, the planar arrangement is so called because a plane can be defined that passes through the rotor origins and the vehicle origin, known as the Vehicle Reference Plane (VRP) as already defined above and identified in FIG. 2. For the non-planar face centred configuration, the rotor pair 1-4 is rotated 90 degrees about the y axis, giving a vehicle of significantly different appearance to the planar configuration, but with similar thrust and torque vectoring properties. Referring to FIGS. 2, 3 and 5, the rotor position and orientation matrices for the planar face centred 6 rotor configuration are:

$$\begin{matrix}{X}_{r} = a [ \begin{matrix}1 & 0 & - 1 & - 1 & 0 & 1 \\ 0 & 1 & 1 & 0 & - 1 & - 1 \\ - 1 & - 1 & 0 & 1 & 1 & 0\end{matrix} ] \\ and & ( 1.19 ) \\ {N}_{r} = [ \begin{matrix}0 & 1 & 0 & 0 & 1 & 0 \\ 1 & 0 & 0 & 1 & 0 & 0 \\ 0 & 0 & 1 & 0 & 0 & 1\end{matrix} ] & ( 1.20 )\end{matrix}$$

and, ignoring the rotor dynamic contribution to the torques on the basis that for practical configurations the dynamic torques will typically be one or two orders of magnitude smaller than the aerodynamic torques, the force and torque equations are

$$\begin{matrix}\underline{F} = [ \begin{matrix}{F}_{2} + {F}_{5} \\ {F}_{1} + {F}_{4} \\ {F}_{3} + {F}_{6}\end{matrix} ] & ( 1.21 ) \\ \underline{T} = [ \begin{matrix}{τ}_{2} + {τ}_{5} + a ( {F}_{1} - {F}_{4} + {F}_{3} - {F}_{6} ) \\ {τ}_{1} + {τ}_{4} + a ( {F}_{5} - {F}_{2} + {F}_{3} - {F}_{6} ) \\ {τ}_{3} + {τ}_{6} + a ( {F}_{1} - {F}_{4} + {F}_{5} - {F}_{2} )\end{matrix} ] & ( 1.22 )\end{matrix}$$

It can be seen from equations (1.21) and (1.22) that the embodiment of the present invention is able to produce control force and moment components in three (orthogonal) dimensions, and so, unlike the prior art helicopter configurations discussed, is capable of full authority force and torque vectoring.

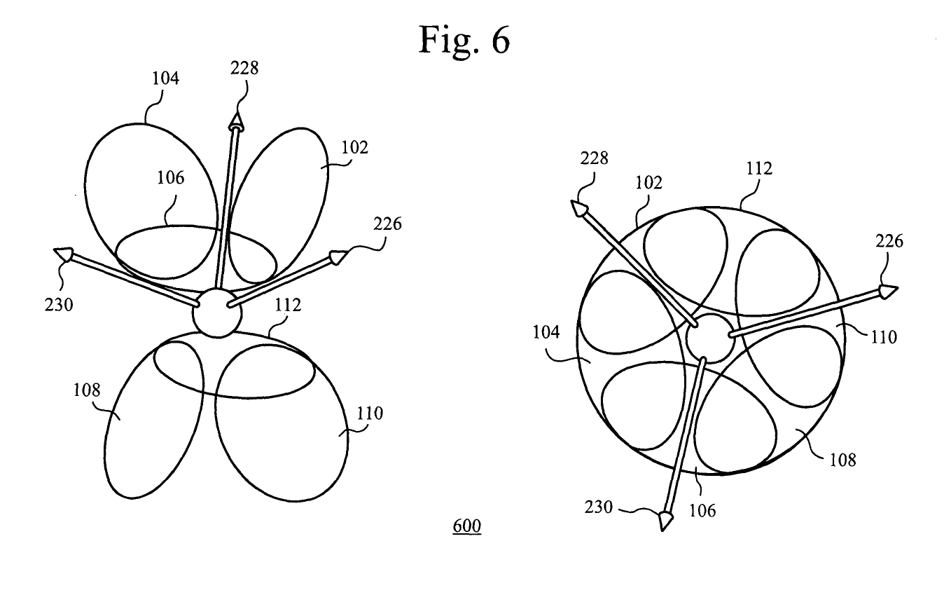

Referring to FIG. 6 and FIG. 23(b), the force and torque equations for the non-planar face centred configuration are

$$\begin{matrix}\underline{F} = [ \begin{matrix}{F}_{2} + {F}_{5} \\ {F}_{1} + {F}_{4} \\ {F}_{3} + {F}_{6}\end{matrix} ] & ( 1.23 ) \\ \underline{T} = [ \begin{matrix}{τ}_{2} + {τ}_{5} + a ( {F}_{1} - {F}_{4} + {F}_{3} - {F}_{6} ) \\ {τ}_{1} + {τ}_{4} + a ( {F}_{5} - {F}_{2} + {F}_{3} - {F}_{6} ) \\ {τ}_{3} + {τ}_{6} + a ( {F}_{4} - {F}_{1} + {F}_{5} - {F}_{2} )\end{matrix} ] & ( 1.24 )\end{matrix}$$

These are identical to (1.21) and (1.22) but for a sign change to F₁ and F₄ in the bottom line of (1.24), demonstrating that from a control perspective, the two embodiments are effectively interchangeable. However, it should be noted that the aerodynamic interference between rotors for the non planar configuration is likely to be higher and the structural arrangement less weight efficient for rolling capable configurations due to the requirement for three separate rolling rims for the second embodiment.

Referring to FIG. 7 and FIG. 23(c), there is shown an edge centred 6 rotor planar embodiment. The rotor position and orientation matrices are:

$$\begin{matrix}{X}_{r} = a [ \begin{matrix}0 & 0 & - 1 & 0 & 0 & 1 \\ 0 & 1 & 0 & 0 & - 1 & 0 \\ - 1 & 0 & 0 & 1 & 0 & 0\end{matrix} ] & ( 1.25 ) \\ {N}_{r} = [ \begin{matrix}0 & 1 & 0 & 0 & 1 & 0 \\ 1 & 0 & 0 & 1 & 0 & 0 \\ 0 & 0 & 1 & 0 & 0 & 1\end{matrix} ] & ( 1.26 )\end{matrix}$$

and once again ignoring the rotor dynamic contribution to the torques, the force and torque equations are

$$\begin{matrix}\underline{F} = [ \begin{matrix}{F}_{2} + {F}_{5} \\ {F}_{1} + {F}_{4} \\ {F}_{3} + {F}_{6}\end{matrix} ] \\ and & ( 1.27 ) \\ \underline{T} = [ \begin{matrix}{τ}_{2} + {τ}_{5} + a ( {F}_{1} - {F}_{4} ) \\ {τ}_{1} + {τ}_{4} + a ( {F}_{3} - {F}_{6} ) \\ {τ}_{3} + {τ}_{6} + a ( {F}_{5} - {F}_{2} )\end{matrix} ] & ( 1.28 )\end{matrix}$$

It will be appreciated from a comparison of the equations of face centred and edge centred rotor embodiments that they are similar but for the fact that in the face centred embodiment each of the characteristic components comprises contributions from two rotor pairs, whereas for the edge centred embodiment the characteristic torque components contains contributions from only a single rotor pair. As a result of this, a key difference is that for the face centred embodiments with orthogonal characteristic (force) axes, the torque characteristic axes are not orthogonal, whereas for an edge centred configuration with orthogonal characteristic axes, the torque characteristic axes are orthogonal. This is discussed further in the description of the control analysis section given below.

### Analysis of the Effect of Characteristic Axes Orientation for Embodiments of the Present Invention

The above embodiments are multi-rotor configurations for which the planes in which the rotors are orientated are orthogonal. This means that the components of force from the rotors will also be orthogonal even though the components of torque will, in general, not be orthogonal. Orthogonality of control force and torque components is advantageous because it at least reduces and preferably minimises the energy (or effort) required to achieve a given force or torque vector. For highly non-orthogonal systems, i.e. cases where α and or β are significantly different to 90 degrees (see equations 1.29 and 1.35) it is possible that significant energy or effort is used by one or more than one rotor to cancel out competing force or torque components. Such a highly non-orthogonal embodiment might also suffer from reduced control authority due to rotor thrust saturation limits being reached at lower overall body axis force levels.

In the following, a general result will be derived for a six rotor vehicle with fan or rotor disc pairs on non-orthogonal planes.

Let three unit vectors nₓ, n_{y}, n_{z} equispaced by the angle α define a coordinate system for the characteristic force axes of a multirotor vehicle. Note that this axis system will in general not be orthogonal apart from the case where α=π/2. The angle α is by definition given by

α=arccos(nₓ,n_{y})=arccos(n_{y},n_{z})=arccos(n_{z},nₓ) (1.29)

where “·” represents the dot product of two vectors.

Let the lines of intersection between the three planes defined by nₓ, n_{y}, n_{z} and the vehicle origin define a characteristic axis system, xyz, for the vehicle. Note that this coordinate system will also in general not be orthogonal except for the case where α=π/2. The basis vectors for the xyz characteristic axis system are by definition:

x=n_{y}×n_{z}, y=n_{z}×nₓ and z=nₓ×n_{y} (1.30)

where “x” represents the cross-product of two vectors.

For the special orthogonal case when α=π/2,

x=nₓ, y=n_{y} and z=n_{z} (1.31)

which corresponds to the configuration shown in FIG. 3.

The following analysis considers the effect of using non-orthogonal planes for the layout of rotors for the face centred configurations shown in FIG. 3. Following on from the above, the Vehicle Reference Plane VRP is defined by the unit normal vector

$${\underline{n}}_{xyz} = \frac{\underline{x} + \underline{y} + \underline{z}}{‖ \underline{x} + \underline{y} + \underline{z} ‖} \qquad ( 1.32 )$$

A derived reference angle φ that represents the angle between the rotor planes and the VRP will be defined and will be referred to as the disc plane angle. Note that for the non planar face centred configuration and the (non planar) edge centred configuration the VRP is defined as a plane parallel to the VRP of the equivalent face centred planar configuration constructed on the same characteristic axes, i.e. same disc plane angle This angle is influential from a design perspective. It represents an intuitive means of trading between propulsive efficiency of embodiments and the degree of orthogonality between the characteristic force and torque axes. The degree of orthogonality between the characteristic force axes can be shown to be equal to the disc plane angle defined above, where

φ=arccos(nₓ·n_{xy})=arccos(n_{y}·n_{xyz})=arccos(n_{z}·n_{xyz}) (1.33)

The relationship between the disc plane angle and the angle α between the characteristic force axes is defined by geometry and can be shown to be given by

$$α = arccos ( - \frac{1}{2} {sin}^{2} φ + {cos}^{2} φ ) \qquad ( 1.34 )$$

The angle, β, between the characteristic torque axes and the disc plane angle can be defined in a similar way and is given by

$$β = π - arccos ( \frac{1}{2} {cos}^{2} φ + {sin}^{2} φ ) \qquad ( 1.35 )$$

Note that the angle β defined above is based on the principal moments obtained from the cross product of rotor forces and position, and does not take into account the aerodynamic and inertial torques produced by the rotors as defined by equation 1.4. As such it is only a partial measure of orthogonality of torque principal axes, however, since the force-distance cross product term will typically be an order of magnitude greater than the aerodynamic and dynamic torques, it provides a useful metric to guide the choice of the disc plane angle based on specified operational requirements.

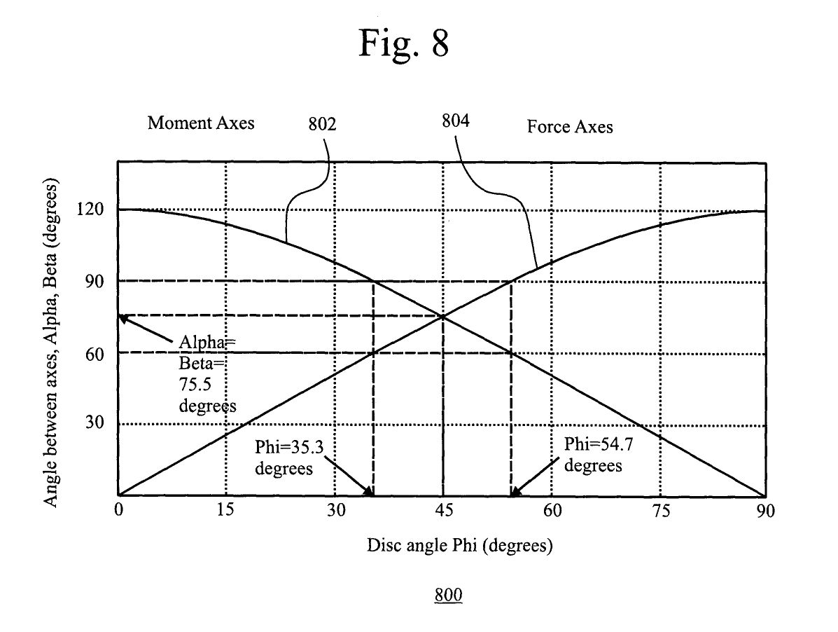

The relationships given by equations (1.34) and (1.35) are shown in the graph 800 of FIG. 8. FIG. 8 identifies, for a six rotor vehicle, the trade-offs between orthogonality of force and torque characteristic axes and the disc plane angle with respect to the vehicle reference plane. The line 802 represents the angle between torque axes. The line 804 represents the angle between the force axes. Efficiency in hover drives the disc angle towards zero. However, this would lead to a fully planar embodiment in which the force characteristic axes are aligned, which, in turn, leads to zero thrust vectoring capability. For a disc angle of 45 degrees, the inter-axis angles for the force and torque axes are both equal to 75.5 degrees. This provides an embodiment with a reasonably efficient hover, and thrust and torque characteristic axes with inter axis angles reasonably close to the ideal of 90 degrees for efficient actuation. In passing, one skilled in the art will understand that authority refers to the region of three dimensional space over which a force or torque vector can be pointed, whereas orthogonality is a measure of actuation system efficiency, with an orthogonal arrangement of the force and torque principal axes being the most efficient. The highest authority and most energy efficient thrust vectoring occurs when the force characteristic axes are orthogonal (alpha=90 degrees). For this case, the disc plane angle is 54.7 degrees and the angle between characteristic torque axes is 60 degrees.

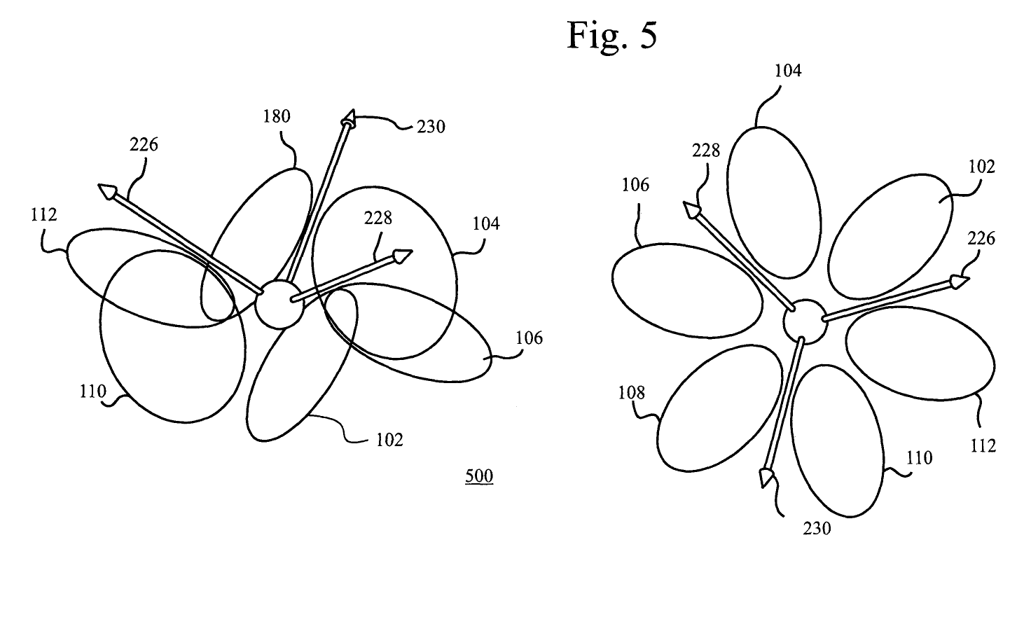

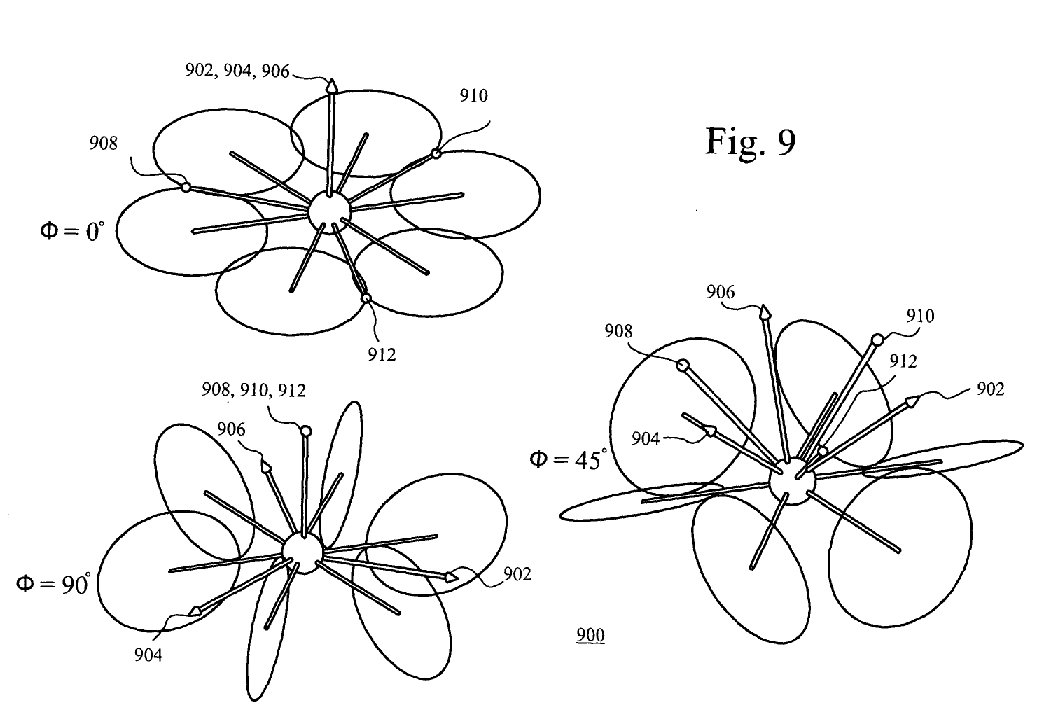

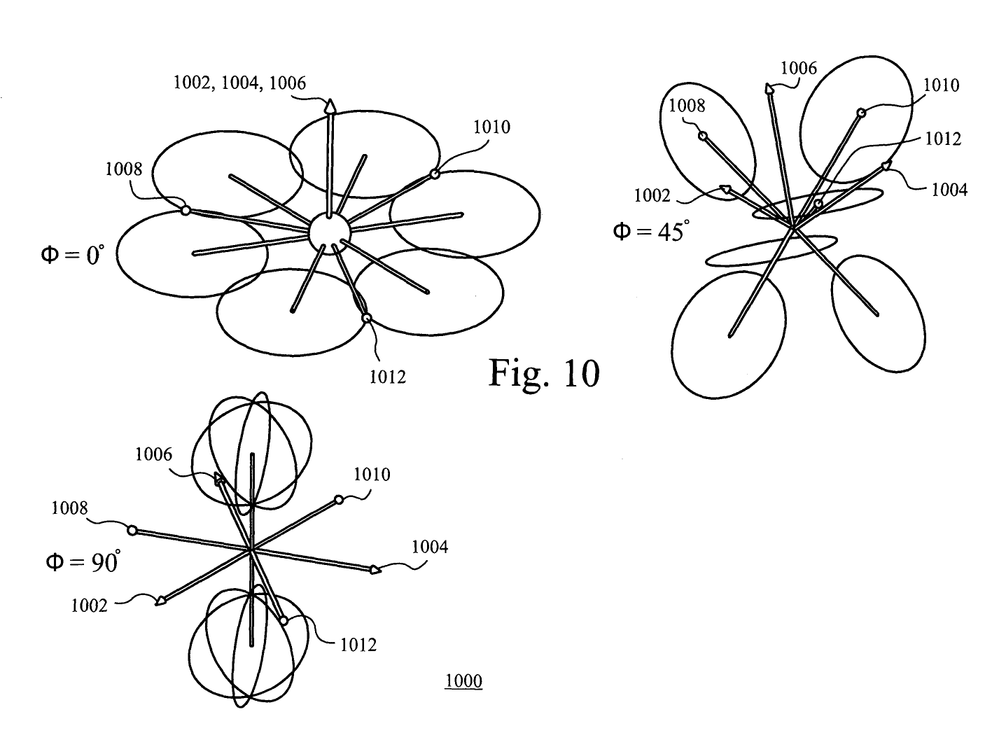

The effect of varying disc plane angle on the geometric configuration of a 6 rotor vehicle for the face centred planar, face centred non planar and edge centred non-planar embodiments is illustrated in FIGS. 9 to 11. For a disc plane angle of zero, all three configurations are equivalent, with all six rotors lying on the same horizontal plane. At a disc plane angle of 45 degrees, the configurations are similar to the orthogonal force configurations introduced in FIGS. 5 to 7. At 90 degrees, the face centred planar configuration is physically viable. However, the torque vectoring capability (within the constraints identified in the discussion beneath equation 1.35) is reduced to zero and hence the vehicle has limited practicality for three dimensional flight. At 90 degrees, the other two configurations are not physically realisable due to intersecting rotors.

Referring to FIG. 9, there is shown a series of diagrams 900 illustrating the force and torque characteristic axes for six rotor face centred planar embodiments for various angles of φ=0,π/4,π/2. The rounded arrows, 908, 910, 912 show the torque characteristic axes. The legend for the figure indicates that the force characteristic axes are shown in red, green and blue, which correspond to labels 902, 904, 906. The legend for the figure indicates that the torque characteristic axes are shown in cyan, magenta and yellow, which correspond to labels 908, 910, 912. Referring to the embodiment in which φ=0, it can be appreciated that the force characteristic axes are collinear, indicating that the thrust vectoring authority is zero, i.e. forces can only be produced in a direction normal to the vehicle reference plane, which, for this configuration, is parallel to the plane of the rotors. On the other hand, the torque characteristic axes are coplanar, indicating that torque vectoring via modification of rotor thrusts is only possible in a single plane parallel to the vehicle reference plane. Note, however, that in practice full authority torque vectoring is achievable if the rotor drag torques, which are normal to the vehicle reference plane, are also included as part of the control strategy. From the above discussion it can be understood this configuration is equivalent to a conventional quad rotor with respect to its force and torque vectoring capability.

Referring to the embodiment in which φ=π/4, it can be appreciated that the characteristic axes are neither collinear nor coplanar indicating that full authority thrust and torque vectoring is available from this configuration. Referring to the embodiment in which φ=π/2, it can be appreciated that the torque characteristics axes are collinear and the force characteristic axes are coplanar. This means the configuration is able to provide thrust vectoring in the vehicle reference plane and rotor thrust based torque vectoring about an axis normal to the vehicle reference plane.

Referring to FIG. 10, there is shown a series of diagrams 1000 illustrating the force and torque characteristic axes for six rotor face centred non-planar embodiments for various disc plane angles of φ=0,π/4,π/2. A comparison of FIG. 10 with FIG. 9 shows that the general arrangement of force and torque characteristic axes for disc plane angles of φ=0 and φ=π/4 is essentially similar for both face centred planar and face centred non planar configurations, and hence the force and torque vectoring characteristics are similar. However, in the limit as φ=π/4, there is a difference in that for the face centred non planar configuration both the force and torque characteristic axes become coplanar, though note that this latter configuration is of limited physical practicality as already mentioned

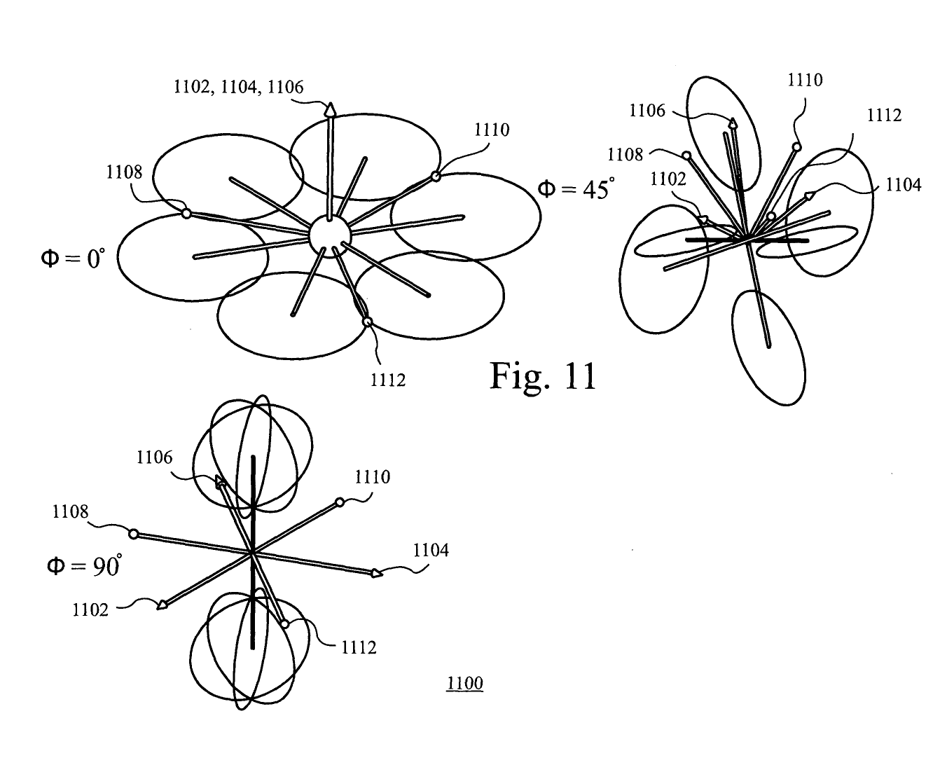

Referring to FIG. 11, there is shown a series of diagrams 1100 illustrating the force and torque characteristic axes for six rotor edge centred non-planar embodiments for various angles of φ=0,π/4,π/2. It can be seen that the φ=0 and φ=π/2 cases are identical to the face centred non planar configuration shown in FIG. 10 and thus will have the same thrust and torque vectoring capability. For the φ=π/4 case the characteristic force and torque axes provide the capability for full authority thrust and torque vectoring but are slightly different to that for the face centred planar and face centred non planar configurations at φ=π/4.

The benefit of the understanding demonstrated with respect to the above configurations for 6 rotor vehicles is that one skilled in the art can chose or design an embodiment that meets the overall needs of the vehicle. For example, the face centred planar configuration shown in FIG. 9 provides a compact solution with the structure being concentrated in a single plane.

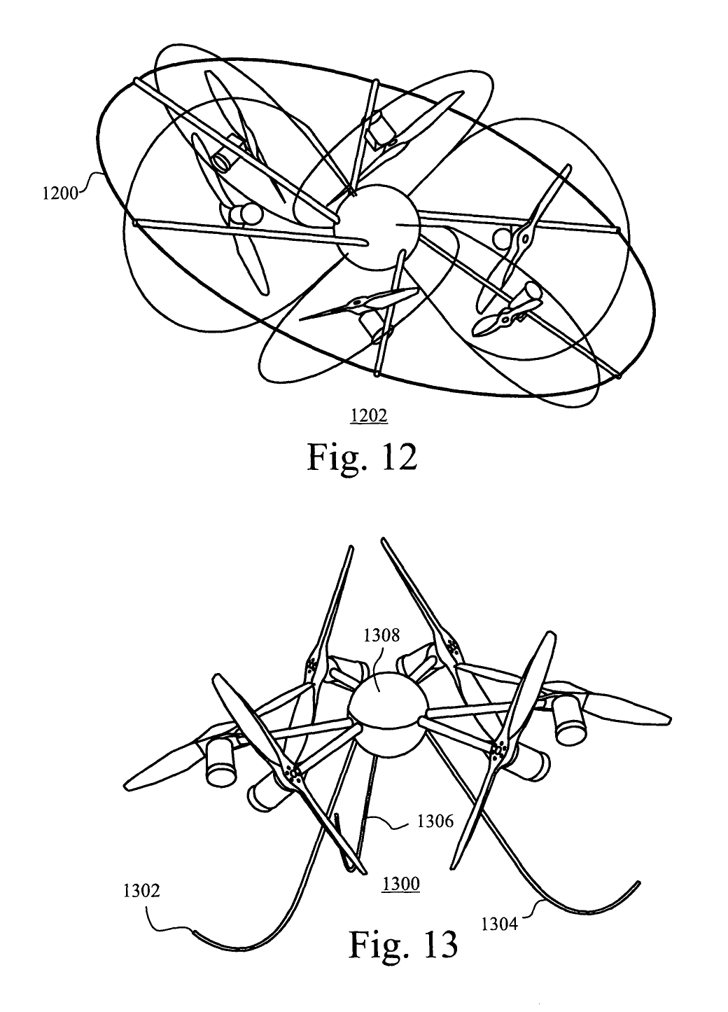

Referring to FIG. 12, it can be appreciated that there is provided a vehicle 1200 having a weight efficient means of providing a rim structure 1202 via which the vehicle 1200 could roll along the ground.

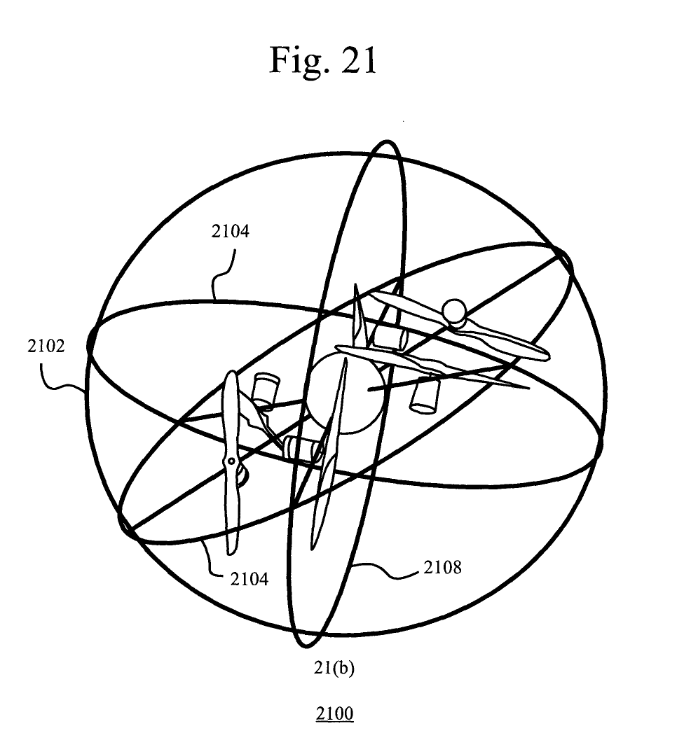

Referring to FIG. 13, there is shown a further embodiment of a face centred planar configuration vehicle 1300 bearing a number of relatively short and hence low mass undercarriage legs 1302, 1304, 1306 attached to a central body 1308 of the vehicle 1300 for flight only operation. On the other hand, the edge centred non-planar configuration enables full orthogonal torque and thrust vectoring, and, therefore, provides a good solution for a vehicle that spends most of its time on the ground and needs to roll efficiently on a number of rims. Embodiments can be realised that use 3 orthogonal rims or 4 rims such as can be seen in FIG. 21(b) However, embodiments are not limited thereto. Embodiments can be realised in which some other number of rims can be used.

FIGS. 12 and 13 show embodiments of face centred planar 6 rotor configurations in which fixed pitch propellers are used such that thrust control is realised via angular speed control. It will be appreciated that using positive and negative angular velocities enables full authority torque and force vectoring, even though fixed pitch propellers might have limited performance when working in reverse.

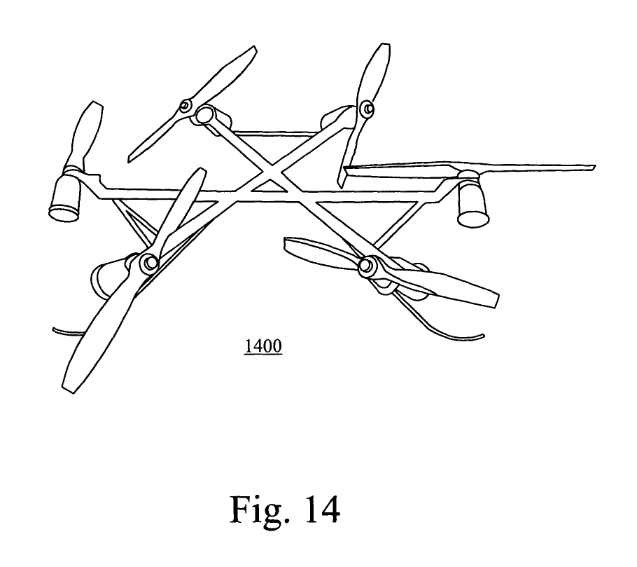

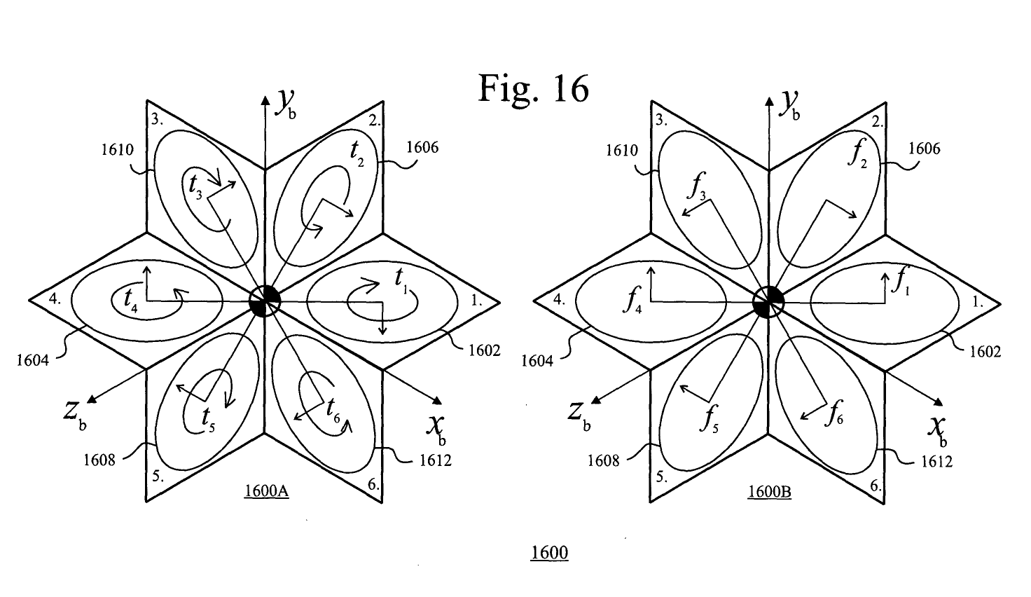

Referring to FIG. 14, there is shown an embodiment of a vehicle 1400 that was physically realised.

Preferred performance constraints or criteria will now be described. Vehicles according to the embodiments of the present invention are capable of hovering using the thrust of just two rotors. Additionally, or alternatively, vehicles are capable of carrying a payload. Some embodiments are capable of carrying a payload weighing 500 grams. The vehicle's take off mass is less than 7 kg.

An embodiment of a vehicle was realised using Orbit 30 type motors available from Pletenberg GmbH. Future Jazz 32.55K speed controllers were used. The mass of a motor and speed controller was 0.373 kg and the typical motor operating power was 440W, which was used to estimate a propulsive specific power of kmsc=1184.6 Wkg-1. The rotors were Zinger 15″×10″ propellers. Table 1 below provides a summary of the constants associated with this embodiment of the present invention.

| Category | Parameter | Value |
|---|---|---|
| Propulsion | Typical specific power | k_{msc} = 1184.6 Wkg⁻¹ |
| | Typical motor operating efficiency | ηₘ = 0.82 |
| | Typical controller efficiency | ηₑ = 0.9 |
| | Battery specific energy density | E_{b} = 514000 Jkg⁻¹ |
| | Battery discharge efficiency | η_{b} = 0.8 |
| Constraints | Payload mass | Mₚ = 0.5 kg |
| | Vehicle mass | M = 5.5 kg |
| Aero- | Air density | ρ = 1.225 kgm⁻¹ |
| dynamic | FIGURE of Merit for rotor | FOM = 0.6 |
| Structural | Structural constant | kₛ = 0.5 m⁻¹ |
| Inertial | Gravitation constant | g = 9.81 ms⁻² |

### 1. Mathematical Analysis and Controller Design

A detailed mathematical analysis of the kinematics, dynamics and control of an embodiment comprising orthogonal face centred rotors will be now be presented. The analysis provides theoretical evidence for the existence of algorithms for control of a practical vehicle, and presents a number of theoretical results relevant to vehicle design and operation.

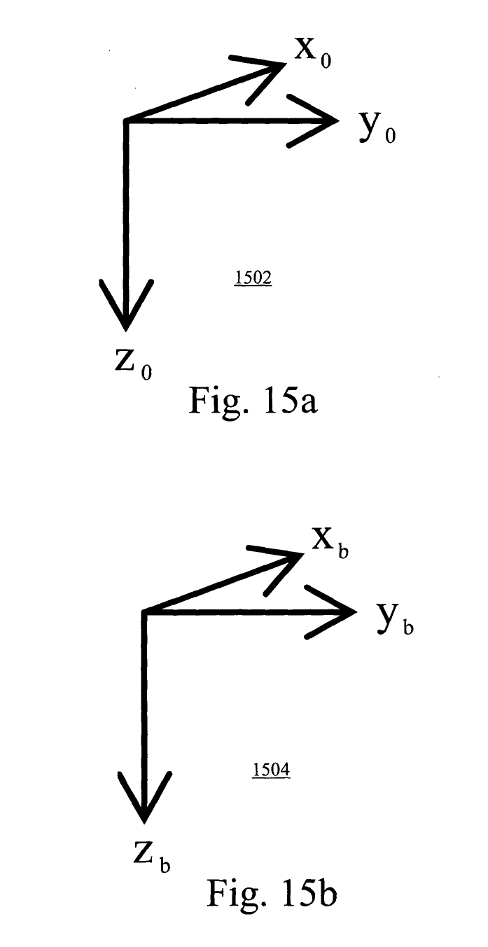

Referring to FIGS. 15a and 15b, there is shown a diagram 1500 of a pair of axes; namely, Earth axes 1502 and body axes 1504.

Let r₀ be any vector (not shown) in the earth axes and r_{b} be the same vector (not shown) in body axes. Let R be a rotation matrix such that it maps all r_{b} into r₀, that is,

r₀=Rr_{b} (2.1)

One skilled in the art appreciates that the three columns of R are the body axes vectors when read in the earth axes. Consequently, R represents a rotation from the earth axes to body axes with everything being read in earth axes.

One skilled in the art also appreciates that it is possible to express the attitude of the body axes as a normalised quaternion q read in the earth axes. Let:

$$\begin{matrix}\underline{q} = ( \begin{matrix}w \\ x \\ y \\ z\end{matrix} ) = ( \begin{matrix}cos \frac{α}{2} \\ \underline{\hat{n}} sin \frac{α}{2}\end{matrix} ) \\ where & ( 2.2 ) \\ {w}^{2} + {x}^{2} + {y}^{2} + {z}^{2} = 1 \\ and & ( 2.3 ) \\ \underline{\hat{n}} ∈ {\underline{R}}^{3} satisfies ‖ \underline{\hat{n}} ‖ = 1 & ( 2.4 )\end{matrix}$$

In the above representation, \hat{n} is a unit vector read in the earth axes and α takes values in the range of (−π,π), that is, αε(−π,π), which is the rotation angle about \hat{n}, in a right hand sense, needed to bring the earth axes on the body axes, with everything read in earth axes. Therefore,

$$( \begin{matrix}0 \\ {\underline{r}}_{0}\end{matrix} ) = \underline{q} \cdot ( \begin{matrix}0 \\ {\underline{r}}_{b}\end{matrix} ) \cdot {\underline{q}}^{*} \qquad ( 2.5 )$$

where:

· is a quaternion multiplication and q* is the quaternion conjugate of q.

It is possible to convert from normalised quaternion representations to rotation matrix representations via the following formulae:

$$\begin{matrix}\underline{q} = ( \begin{matrix}w \\ x \\ y \\ z\end{matrix} ) ⇔ R = ( \begin{matrix}1 - 2 {y}^{2} - 2 {z}^{2} & 2 xy - 2 wz & 2 zx + 2 wy \\ 2 xy + 2 wz & 1 - 2 {x}^{2} - 2 {z}^{2} & 2 yz - 2 wz \\ 2 zx - 2 wy & 2 yz + 2 wz & 1 - 2 {x}^{2} - 2 {y}^{2}\end{matrix} ) \\ where & ( 2.6 ) \\ {w}^{2} + {x}^{2} + {y}^{2} + {z}^{2} = 1 \\ and & ( 2.7 ) \\ {RR}^{T} = I , det R = + 1 & ( 2.8 )\end{matrix}$$

### 2. Analysis of Forces and Moments

There will now follow an analysis of the forces and moments associated with embodiments of orthogonal face centred rotor vehicles. The analysis will be conducted, firstly, for control via constant speed variable pitch rotors and, secondly, for variable speed fixed pitch rotors.

### 2.1 Control Via Constant Speed Variable Pitch Rotors

### 2.1.1 Forces

FIG. 16 depicts a pair of diagrams 1600 showing the torques, spin directions and forces associated with the rotors of an embodiment of an orthogonal face centred rotor vehicle.

It can be appreciated that the rotors are arranged is pairs in three mutually orthogonal planes as was discussed with reference to FIGS. 2 and 3. It can be seen that the first 1602 and fourth 1604 rotors have opposite torques, t₁ and t₄, and opposite spin directions. The same applies to the second 1606 and fifth 1608 rotors, which have opposite torques, t₂ and t₅, and opposite spin directions. The third 1610 and sixth 1612 rotors have oppositely directed torques, t₃ and t₆, and spin directions.

Referring to FIG. 16, there is shown the forces associated with the rotors according to the embodiment. It can be appreciated that the forces or thrusts generated by the first 1602 and fourth 1604 rotors operate at a distance of/from the origin of the vehicle axes x_{b}y_{b}z_{b} and are in the same direction. It will be appreciated that the “a” described above with reference to FIG. 3 and the present “l” are one and the same. Similarly, the forces associated with the second 1606 and fifth 1608 rotors operate at a distance of l from the origin of the vehicle axes x_{b}y_{b}z_{b} and are in the same direction. The same applies to the forces associated with the third 1610 and sixth 1612 rotors.

The variable pitch control strategy can produce forces in the positive and negative directions. The force varies with the rotor collective pitch angle, αᵢ. Therefore, for a given fan or rotor, i, the force or thrust generated for a constant speed of rotation is

fᵢ=kᵢαᵢ (2.11)

Note that k₁ is a scalar constant coefficient of proportionality that relates rotor pitch angle to force as in (2.11) and hence has units N/rad.

Referring to FIG. 16, the forces in the body axes are given by:

$${\underline{f}}_{b} = ( \begin{matrix}0 & 1 & 0 & 0 & 1 & 0 \\ 1 & 0 & 0 & 1 & 0 & 0 \\ 0 & 0 & 1 & 0 & 0 & 1\end{matrix} ) ( \begin{matrix}{f}_{1} \\ {f}_{2} \\ {f}_{3} \\ {f}_{4} \\ {f}_{5} \\ {f}_{6}\end{matrix} ) \qquad ( 2.12 )$$

The forces in the earth axes are given by:

$${\underline{f}}_{0} = {k}_{1} R ( \begin{matrix}0 & 1 & 0 & 0 & 1 & 0 \\ 1 & 0 & 0 & 1 & 0 & 0 \\ 0 & 0 & 1 & 0 & 0 & 1\end{matrix} ) ( \begin{matrix}{α}_{1} \\ {α}_{2} \\ {α}_{3} \\ {α}_{4} \\ {α}_{5} \\ {α}_{6}\end{matrix} ) \qquad ( 2.13 )$$

It will be appreciated that the force f₀ is the resultant force or overall thrust vector acting on the vehicle.

### 2.1.2 Torque

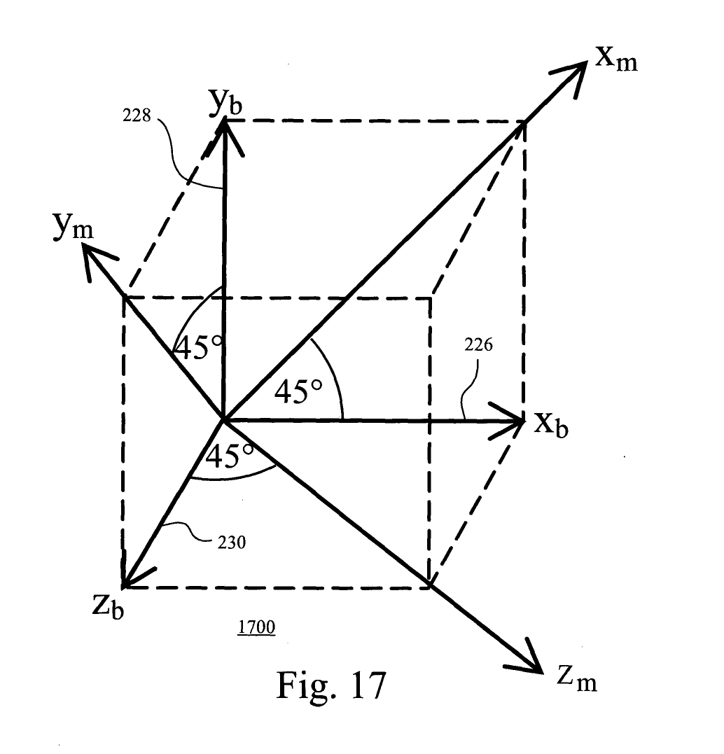

Next the torques will be considered. FIG. 17 shows a diagram 1700 of the torque xₘyₘzₘ and body axes x_{b}y_{b}z_{b} of the vehicle. One skilled in the art will appreciate that the propulsive reaction torque for a given rotor, i, is given by:

tᵢ=k₀+k₂αᵢ² (2.14)

Note that k₂ is a scalar constant coefficient of proportionality that relates rotor pitch angle to aerodynamic reaction drag experienced by the rotor as given in (2.14) and hence has units Nm/rad². On the other hand, k₀ is the residual aerodynamic reaction drag experienced at zero rotor pitch angle with units Nm.

The motor reaction torques about the body axis are given by:

$${\underline{t}}_{{b}_{r}} = {k}_{2} ( \begin{matrix}{α}_{2}^{2} - {α}_{5}^{2} \\ {α}_{4}^{2} - {α}_{1}^{2} \\ {α}_{6}^{2} - {α}_{3}^{2}\end{matrix} ) \qquad ( 2.15 )$$

The differential force moments about the principal torque axes xₘyₘzₘ, which are not orthogonal, are given by:

tₓ_{ₘ}=l(f₃−f₆) (2.16)

t_{y}_{ₘ}=l(f₅−f₂) (2.17)

t_{z}_{ₘ}=l(f₁−f₄) (2.18)

The differential force moments can be expressed in the body axes as:

$${\underline{t}}_{{b}_{d}} = ( \begin{matrix}\frac{1}{\sqrt{2}} & 0 & \frac{1}{\sqrt{2}} \\ \frac{1}{\sqrt{2}} & \frac{1}{\sqrt{2}} & 0 \\ 0 & \frac{1}{\sqrt{2}} & \frac{1}{\sqrt{2}}\end{matrix} ) ( \begin{matrix}{k}_{1} l ( {α}_{3} - {α}_{6} ) \\ {k}_{1} l ( {α}_{5} - {α}_{2} ) \\ {k}_{1} l ( {α}_{1} - {α}_{4} )\end{matrix} ) \qquad ( 2.19 )$$

Combining both types of torques and rotating into earth axes gives a total torque, t₀, of:

$${\underline{t}}_{0} = R [ \begin{matrix}\frac{{k}_{1} l}{\sqrt{2}} ( \begin{matrix}1 & 0 & 1 \\ 1 & 1 & 0 \\ 0 & 1 & 1\end{matrix} ) ( \begin{matrix}0 & 0 & 1 & 0 & 0 & - 1 \\ 0 & - 1 & 0 & 0 & 1 & 0 \\ 1 & 0 & 0 & - 1 & 0 & 0\end{matrix} ) ( \begin{matrix}{α}_{1} \\ {α}_{2} \\ {α}_{3} \\ {α}_{4} \\ {α}_{5} \\ {α}_{6}\end{matrix} ) + \\ {k}_{2} ( \begin{matrix}0 & 1 & 0 & 0 & - 1 & 0 \\ - 1 & 0 & 0 & 1 & 0 & 0 \\ 0 & 0 & - 1 & 0 & 0 & 1\end{matrix} ) ( \begin{matrix}{α}_{1}^{2} \\ {α}_{2}^{2} \\ {α}_{3}^{2} \\ {α}_{4}^{2} \\ {α}_{5}^{2} \\ {α}_{6}^{2}\end{matrix} )\end{matrix} ] \qquad ( 2.20 )$$

which reduces to:

$${\underline{t}}_{0} = R [ \begin{matrix}\frac{{k}_{1} l}{\sqrt{2}} ( \begin{matrix}1 & 0 & 1 & - 1 & 0 & - 1 \\ 0 & - 1 & 1 & 0 & 1 & - 1 \\ 1 & - 1 & 0 & - 1 & 1 & 0\end{matrix} ) ( \begin{matrix}{α}_{1} \\ {α}_{2} \\ {α}_{3} \\ {α}_{4} \\ {α}_{5} \\ {α}_{6}\end{matrix} ) + \\ {k}_{2} ( \begin{matrix}0 & 1 & 0 & 0 & - 1 & 0 \\ - 1 & 0 & 0 & 1 & 0 & 0 \\ 0 & 0 & - 1 & 0 & 0 & 1\end{matrix} ) ( \begin{matrix}{α}_{1}^{2} \\ {α}_{2}^{2} \\ {α}_{3}^{2} \\ {α}_{4}^{2} \\ {α}_{5}^{2} \\ {α}_{6}^{2}\end{matrix} )\end{matrix} ] \qquad ( 2.21 )$$

### 2.1.3 Combined Forces and Torques

From the above analysis it can be appreciated that the forces and torques acting on the vehicle are given by:

$$\begin{matrix} ( \begin{matrix}{\underline{f}}_{0} \\ {\underline{t}}_{0}\end{matrix} ) = ( \begin{matrix}R & 0 \\ 0 & R\end{matrix} ) [ ( \begin{matrix}P & P \\ Q & - Q\end{matrix} ) ( \begin{matrix}{α}_{1} \\ {α}_{2} \\ {α}_{3} \\ {α}_{4} \\ {α}_{5} \\ {α}_{6}\end{matrix} ) + ( \begin{matrix}0 & 0 \\ S & - S\end{matrix} ) ( \begin{matrix}{α}_{1}^{2} \\ {α}_{2}^{2} \\ {α}_{3}^{2} \\ {α}_{4}^{2} \\ {α}_{5}^{2} \\ {α}_{6}^{2}\end{matrix} ) ] & ( 2.22 ) \\ ⇔ \frac{1}{2} ( \begin{matrix}I & I \\ I & - I\end{matrix} ) ( \begin{matrix}{P}^{- 1} {R}^{T} & 0 \\ 0 & {Q}^{- 1}\end{matrix} ) ( \begin{matrix}{\underline{f}}_{0} \\ {\underline{t}}_{b}\end{matrix} ) = ( \begin{matrix}{α}_{1} \\ {α}_{2} \\ {α}_{3} \\ {α}_{4} \\ {α}_{5} \\ {α}_{6}\end{matrix} ) + \frac{1}{2} ( \begin{matrix}{Q}^{- 1} S \\ - {Q}^{- 1} S\end{matrix} ) ( \begin{matrix}I & - I\end{matrix} ) ( \begin{matrix}{α}_{1}^{2} \\ {α}_{2}^{2} \\ {α}_{3}^{2} \\ {α}_{4}^{2} \\ {α}_{5}^{2} \\ {α}_{6}^{2}\end{matrix} ) \\ where & ( 2.23 ) \\ P = {k}_{1} ( \begin{matrix}0 & 1 & 0 \\ 1 & 0 & 0 \\ 0 & 0 & 1\end{matrix} ) & ( 2.24 ) \\ Q = \frac{{k}_{1} l}{\sqrt{2}} ( \begin{matrix}1 & 0 & 1 \\ 0 & - 1 & 1 \\ 1 & - 1 & 0\end{matrix} ) & ( 2.25 ) \\ S = {k}_{2} ( \begin{matrix}0 & 1 & 0 \\ - 1 & 0 & 0 \\ 0 & 0 & - 1\end{matrix} ) & ( 2.26 )\end{matrix}$$

In directing or controlling the vehicle, assume that the following net or resultant force, f₀, and torque, t₀, are desired

$${\underline{f}}_{0} = ( \begin{matrix}{v}_{1} \\ {v}_{2} \\ {v}_{3}\end{matrix} ) and {\underline{t}}_{b} = ( \begin{matrix}{v}_{4} \\ {v}_{5} \\ {v}_{6}\end{matrix} )$$

and setting

$$( \begin{matrix}{u}_{1} \\ {u}_{2} \\ {u}_{3} \\ {u}_{4} \\ {u}_{5} \\ {u}_{6}\end{matrix} ) = \frac{1}{2} ( \begin{matrix}I & I \\ I & - I\end{matrix} ) ( \begin{matrix}{P}^{- 1} {R}^{T} & 0 \\ 0 & {Q}^{- 1}\end{matrix} ) ( \begin{matrix}{v}_{1} \\ {v}_{2} \\ {v}_{3} \\ {v}_{4} \\ {v}_{5} \\ {v}_{6}\end{matrix} ) \qquad ( 2.27 )$$

to give

$$( \begin{matrix}{u}_{1} \\ {u}_{2} \\ {u}_{3} \\ {u}_{4} \\ {u}_{5} \\ {u}_{6}\end{matrix} ) = ( \begin{matrix}{α}_{1} \\ {α}_{2} \\ {α}_{3} \\ {α}_{4} \\ {α}_{5} \\ {α}_{6}\end{matrix} ) + \frac{1}{2} ( \begin{matrix}{Q}^{- 1} S \\ - {Q}^{- 1} S\end{matrix} ) ( \begin{matrix}I & - 1\end{matrix} ) ( \begin{matrix}{α}_{1}^{2} \\ {α}_{2}^{2} \\ {α}_{3}^{2} \\ {α}_{4}^{2} \\ {α}_{5}^{2} \\ {α}_{6}^{2}\end{matrix} ) \qquad ( 2.28 )$$

Solving equation 2.28 for the pitch angles, αᵢ, gives

$$\begin{matrix}( \begin{matrix}{α}_{4} \\ {α}_{5} \\ {α}_{6}\end{matrix} ) = {[ I + {Q}^{- 1} S ( \begin{matrix}{u}_{1} + {u}_{4} & 0 & 0 \\ 0 & {u}_{2} + {u}_{5} & 0 \\ 0 & 0 & {u}_{3} + {u}_{6}\end{matrix} ) ]}^{- 1} \\ [ ( \begin{matrix}{u}_{4} \\ {u}_{5} \\ {u}_{6}\end{matrix} ) + \frac{1}{2} {Q}^{- 1} S ( \begin{matrix}{( {u}_{1} + {u}_{4} )}^{2} \\ {( {u}_{2} + {u}_{5} )}^{2} \\ {( {u}_{3} + {u}_{6} )}^{2}\end{matrix} ) ] \\ and & ( 2.29 ) \\ ( \begin{matrix}{α}_{1} \\ {α}_{2} \\ {α}_{3}\end{matrix} ) = ( \begin{matrix}{u}_{1} + {u}_{4} \\ {u}_{2} + {u}_{5} \\ {u}_{3} + {u}_{6}\end{matrix} ) - ( \begin{matrix}{α}_{4} \\ {α}_{5} \\ {α}_{6}\end{matrix} ) & ( 2.30 )\end{matrix}$$

Therefore, setting the pitch angles or angles of attack as indicated by the solutions for αᵢ will achieve the vehicle's desired acceleration and torque vectors. One skilled in the art will appreciate that for αᵢ>0 there is expansion of the torque axes via the motor reaction torques and for αᵢ<0 there is contraction of the torque axes via the motor reaction torques, that is, the orthant defined by the torque axes xₘyₘzₘ increases and decreases in size respectively.

### 2.2 Control Via Variable Speed Fixed Pitch Rotors

Next will be considered an embodiment of a vehicle comprising 6 orthogonal face centred planar rotors in which the pitch of the rotor blades is fixed and the speed of rotation can be varied.

### 2.2.1 Forces

The variable speed control strategy relies on producing forces in the positive direction only, that is, forces are restricted to the positive orthant. One skilled in the art appreciates that an orthant is one of the regions enclosed by the semi-axes, e.g. in 2 dimensional space, an orthant is one of the four quadrants enclosed by the semi-axes; and in 3 dimensional space, an orthant is one of the eight octants enclosed by the semi-axes) as can be appreciated from, for example, I. N Branshtain, K. A. Semendyaer, “Mathematics Handbook for Engineers”, Moscow, Nauka, 1980, p. 235, which is incorporated herein by reference for all purposes.

One skilled in the art also appreciates that the force of a given rotor, i, varies as the square of rotor rotational velocity, uᵢ, in rad/sec, that is:

fₜ=k₁uᵢ² (2.31)

Note that k₁, in this subsection, is a scalar constant coefficient of proportionality and relates rotor spin speed in rad/sec to force in N as given in (2.31).

The forces in the body axes are given by:

$${\underline{f}}_{b} = ( \begin{matrix}0 & 1 & 0 & 0 & 1 & 0 \\ 1 & 0 & 0 & 1 & 0 & 0 \\ 0 & 0 & 1 & 0 & 0 & 1\end{matrix} ) ( \begin{matrix}{f}_{1} \\ {f}_{2} \\ {f}_{3} \\ {f}_{4} \\ {f}_{5} \\ {f}_{6}\end{matrix} ) \qquad ( 2.32 )$$

The forces in the earth axes are given by:

$${\underline{f}}_{0} = {k}_{1} R ( \begin{matrix}0 & 1 & 0 & 0 & 1 & 0 \\ 1 & 0 & 0 & 1 & 0 & 0 \\ 0 & 0 & 1 & 0 & 0 & 1\end{matrix} ) ( \begin{matrix}{u}_{1}^{2} \\ {u}_{2}^{2} \\ {u}_{3}^{2} \\ {u}_{4}^{2} \\ {u}_{5}^{2} \\ {u}_{6}^{2}\end{matrix} ) \qquad ( 2.33 )$$

Although embodiments described herein use the same k₁, vehicles are not limited thereto. Embodiments can be realised that use respective values of kᵢ for each of the rotors.

### 2.2.2 Torques

Referring again to FIGS. 16 and 17, the propulsive reaction torque, tᵢ, for a given rotor, i, is given by:

tᵢ=k₂uᵢ² (2.34)

Note that k₂, in this subsection, is a scalar constant coefficient of proportionality and relates rotor spin speed in rad/sec to torque in Nm as given in (2.34).

The motor reaction torques, t_{b}, about the body axis is given by:

$${\underline{t}}_{b ,} = {k}_{2} ( \begin{matrix}{u}_{2}^{2} - {u}_{5}^{2} \\ {u}_{4}^{2} - {u}_{1}^{2} \\ {u}_{6}^{2} - {u}_{3}^{2}\end{matrix} ) \qquad ( 2.35 )$$

The differential force moment about the moment axes, which are not orthogonal, is given by:

tₓ_{ₘ}=l(f₃−f₆) (2.36)

t_{y}_{ₘ}=l(f₅−f₂) (2.37)

t_{z}_{ₘ}=l(f₁−f₄) (2.38)

These differential force moments can be expressed in body axes as:

$${\underline{t}}_{{b}_{T}} = ( \begin{matrix}\frac{1}{\sqrt{2}} & 0 & \frac{1}{\sqrt{2}} \\ \frac{1}{\sqrt{2}} & \frac{1}{\sqrt{2}} & 0 \\ 0 & \frac{1}{\sqrt{2}} & \frac{1}{\sqrt{2}}\end{matrix} ) ( \begin{matrix}{k}_{1} l ( {u}_{3}^{2} - {u}_{6}^{2} ) \\ {k}_{1} l ( {u}_{5}^{2} - {u}_{2}^{2} ) \\ {k}_{1} l ( {u}_{1}^{2} - {u}_{4}^{2} )\end{matrix} ) \qquad ( 2.39 )$$

Combining both torques and rotating into earth axes gives:

$${\underline{t}}_{0} = R [ \begin{matrix}\frac{{k}_{1} l}{\sqrt{2}} ( \begin{matrix}1 & 0 & 1 \\ 1 & 1 & 0 \\ 0 & 1 & 1\end{matrix} ) ( \begin{matrix}0 & 0 & 1 & 0 & 0 & - 1 \\ 0 & - 1 & 0 & 0 & 1 & 0 \\ 1 & 0 & 0 & - 1 & 0 & 0\end{matrix} ) ( \begin{matrix}{u}_{1}^{2} \\ {u}_{2}^{2} \\ {u}_{3}^{2} \\ {u}_{4}^{2} \\ {u}_{5}^{2} \\ {u}_{6}^{2}\end{matrix} ) + \\ {k}_{2} ( \begin{matrix}0 & 1 & 0 & 0 & - 1 & 0 \\ - 1 & 0 & 0 & 1 & 0 & 0 \\ 0 & 0 & - 1 & 0 & 0 & 1\end{matrix} ) ( \begin{matrix}{u}_{1}^{2} \\ {u}_{2}^{2} \\ {u}_{3}^{2} \\ {u}_{4}^{2} \\ {u}_{5}^{2} \\ {u}_{6}^{2}\end{matrix} )\end{matrix} ] \qquad ( 2.40 )$$

which reduces to:

$${\underline{t}}_{0} = R [ \begin{matrix}\frac{{k}_{1} l}{\sqrt{2}} ( \begin{matrix}1 & 0 & 1 & - 1 & 0 & - 1 \\ 0 & - 1 & 1 & 0 & 1 & - 1 \\ 1 & - 1 & 0 & - 1 & 1 & 0\end{matrix} ) ( \begin{matrix}{u}_{1}^{2} \\ {u}_{2}^{2} \\ {u}_{3}^{2} \\ {u}_{4}^{2} \\ {u}_{5}^{2} \\ {u}_{6}^{2}\end{matrix} ) + \\ {k}_{2} ( \begin{matrix}0 & 1 & 0 & 0 & - 1 & 0 \\ - 1 & 0 & 0 & 1 & 0 & 0 \\ 0 & 0 & - 1 & 0 & 0 & 1\end{matrix} ) ( \begin{matrix}{u}_{1}^{2} \\ {u}_{2}^{2} \\ {u}_{3}^{2} \\ {u}_{4}^{2} \\ {u}_{5}^{2} \\ {u}_{6}^{2}\end{matrix} )\end{matrix} ] \qquad ( 2.41 )$$

### 2.2.3 Combined Forces and Torques

From the above analysis one skilled in the art appreciates that the forces, f₀, and torques, tₒ, acting on the vehicle are given by:

$$\begin{matrix}( \begin{matrix}{\underline{f}}_{0} \\ {\underline{t}}_{0}\end{matrix} ) = ( \begin{matrix}R & 0 \\ 0 & R\end{matrix} ) [ ( \begin{matrix}P & P \\ ( Q + S ) & - ( Q + S )\end{matrix} ) ( \begin{matrix}{u}_{1}^{2} \\ {u}_{2}^{2} \\ {u}_{3}^{2} \\ {u}_{4}^{2} \\ {u}_{5}^{2} \\ {u}_{6}^{2}\end{matrix} ) ] \\ where & ( 2.42 ) \\ P = {k}_{1} ( \begin{matrix}0 & 1 & 0 \\ 1 & 0 & 0 \\ 0 & 0 & 1\end{matrix} ) & ( 2.43 ) \\ Q = \frac{{k}_{1} l}{\sqrt{2}} ( \begin{matrix}1 & 0 & 1 \\ 0 & - 1 & 1 \\ 1 & - 1 & 0\end{matrix} ) & ( 2.44 ) \\ S = {k}_{2} ( \begin{matrix}0 & 1 & 0 \\ - 1 & 0 & 0 \\ 0 & 0 & - 1\end{matrix} ) & ( 2.45 )\end{matrix}$$

It will be appreciated by those skilled in the art that expansion (and contraction) of the torque characteristics axes can be realised by appropriate selection of spin directions. This expansion or contraction of torque axes depends on the relative values of k₂ and k₁l.

In directing or controlling the vehicle, assume that the following net or resultant force, f₀, and torque, t₀, are desired

$${\underline{f}}_{0} = ( \begin{matrix}{v}_{1} \\ {v}_{2} \\ {v}_{3}\end{matrix} ) and {\underline{t}}_{b} = ( \begin{matrix}{v}_{4} \\ {v}_{5} \\ {v}_{6}\end{matrix} )$$

and setting

$$( \begin{matrix}{u}_{1}^{2} \\ {u}_{2}^{2} \\ {u}_{3}^{2} \\ {u}_{4}^{2} \\ {u}_{5}^{2} \\ {u}_{6}^{2}\end{matrix} ) = \frac{1}{2} ( \begin{matrix}I & I \\ I & - I\end{matrix} ) ( \begin{matrix}{P}^{- 1} {R}^{T} & 0 \\ 0 & {( Q + S )}^{- 1}\end{matrix} ) ( \begin{matrix}{v}_{1} \\ {v}_{2} \\ {v}_{3} \\ {v}_{4} \\ {v}_{5} \\ {v}_{6}\end{matrix} ) \qquad ( 2.46 )$$

To get the rotational speeds for reach rotor, uᵢ, take the square-root of each component in the vector.

Also note that

$$\begin{matrix}{P}^{- 1} = \frac{1}{{k}_{1}} ( \begin{matrix}0 & 1 & 0 \\ 1 & 0 & 0 \\ 0 & 0 & 1\end{matrix} ) & ( 2.47 ) \\ and & \\ det ( Q + S ) = \frac{{( {k}_{1} l )}^{3}}{\sqrt{2}} + \frac{3 {( {k}_{1} l )}^{2} {k}_{2}}{2} - {k}_{2}^{3} & ( 2.48 ) \\ det ( Q + S ) = \frac{{( {k}_{1} l )}^{3}}{\sqrt{2}} + {k}_{2} ( \frac{3 {( {k}_{1} l )}^{2}}{2} - {k}_{2}^{2} ) & ( 2.49 )\end{matrix}$$

Therefore, for

$${k}_{2} < \sqrt{\frac{3}{2}} {k}_{1} l \qquad ( 2.50 )$$

gives

det(Q+S)>0 (2.51)

This is indeed the case in practice as k₂ is negligible compared to k₁l. Then, det(Q+S)>0 guarantees that (Q+S) is invertible.

### 3. Boundary Envelope for Maximum Force

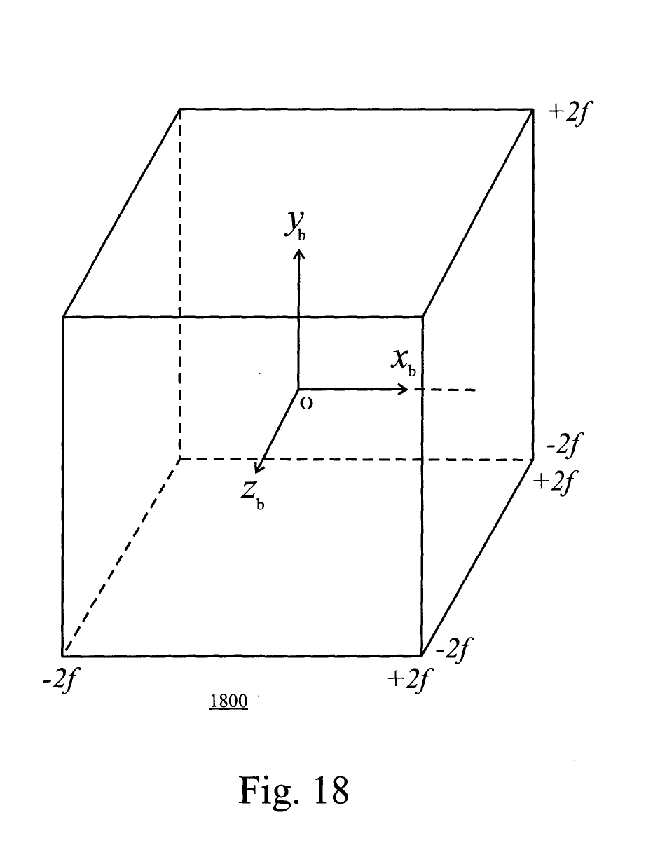

Referring to FIG. 18, there is shown the boundary envelope 1800 for maximum force from an orthogonal face centred planar rotor vehicle according to an embodiment. The boundary envelope is a cube 1802.

One skilled in the art appreciates that the maximum force is given by:

f_{mzx}=\sqrt{(2f)²+(2f)²+(2f)²}=\sqrt{3}f (2.52)

The minimum force on the boundary envelope is given by:

fₘᵢₙ=2f (2.53)

If the maximal force direction in the positive orthant of the body axes is desired to be pointing upwards then the vector for that force is given by

$$( \begin{matrix}0 \\ 0 \\ - 1\end{matrix} ) = R ( \begin{matrix}\frac{1}{\sqrt{3}} \\ \frac{1}{\sqrt{3}} \\ \frac{1}{\sqrt{3}}\end{matrix} ) \qquad ( 2.54 )$$

If additionally, x_{b} is to be in the (x₀,z₀) plane in the positive xₒ and negative z₀ orthant then:

$$R = [ \begin{matrix}\sqrt{\frac{2}{3}} & - \frac{1}{\sqrt{6}} & - \frac{1}{\sqrt{6}} \\ 0 & - \frac{1}{\sqrt{2}} & \frac{1}{\sqrt{2}} \\ - \frac{1}{\sqrt{3}} & - \frac{1}{\sqrt{3}} & - \frac{1}{\sqrt{3}}\end{matrix} ] \qquad ( 2.55 )$$

This is equivalent to a normalised quaternion:

$$\underline{q} = ( \begin{matrix}0. 3648 \\ - 0. 8806 \\ 0. 1159 \\ 0. 2798\end{matrix} )$$

### 4. Kinematics

Let the current position, q(t), read in earth axes, of the vehicle at a given time, t, be

$$given by \underline{q} ( t ) = ( \begin{matrix}cos \frac{α ( t )}{2} \\ {n}_{\_}^{\hat{}} ( t ) sin \frac{α ( t )}{2}\end{matrix} ) \qquad ( 2.57 )$$

where this given normalised quaternion is parameterised in terms of an angle α and a unit vector \hat{n}.

Suppose the vehicle is rotating with angular velocity ω₀ read in the earth axes, then, after time δt, there is an additional change in attitude given by a normalised quaternion r(t) as:

$$\underline{r} ( t ) = ( \begin{matrix}cos ( \frac{‖ {\underline{ω}}_{0} ‖ ( δ t )}{2} ) \\ \frac{{\underline{ω}}_{0}}{‖ {\underline{ω}}_{0} ‖} sin ( \frac{‖ {ω}_{0} ‖ ( δ t )}{2} )\end{matrix} ) \qquad ( 2.58 )$$

Consequently;

$$\begin{matrix}{q}_{\_}^{.} ( t ) = {lim}_{δ t \to 0} \frac{( \underline{r} ( t ) ∘ \underline{q} ( t ) - \underline{q} ( t ) )}{( δ t )} & ( 2.59 ) \\ {q}_{\_}^{.} ( t ) = ( {lim}_{δ t \to 0} \frac{\underline{r} ( t ) - ( \begin{matrix}1 \\ 0 \\ 0 \\ 0\end{matrix} )}{δ t} ) ∘ \underline{q} ( t ) & ( 2.60 )\end{matrix}$$

which gives velocity for the vehicle, expressed in quaternions, of

$${q}_{\_}^{.} ( t ) = ( \begin{matrix}0 \\ \frac{1}{2} {\underline{ω}}_{0}\end{matrix} ) ∘ \underline{q} ( t ) \qquad ( 2.61 )$$

Therefore;

$${q}_{\_}^{.} ( t ) = \frac{1}{2} ( \begin{matrix}0 \\ {\underline{ω}}_{0}\end{matrix} ) ∘ \underline{q} ( t ) \qquad ( 2.62 )$$

One skilled in the art appreciates that

$$( \begin{matrix}0 \\ {\underline{ω}}_{0}\end{matrix} ) = \underline{q} ∘ ( \begin{matrix}0 \\ {\underline{ω}}_{b}\end{matrix} ) ∘ {\underline{q}}^{*} \qquad ( 2.63 )$$

It, therefore, follows that the velocity, \dot{q}(t), of the vehicle at time t is given by

$${q}_{\_}^{.} ( t ) = \frac{1}{2} \underline{q} ( t ) ∘ ( \begin{matrix}0 \\ {\underline{ω}}_{b}\end{matrix} ) \qquad ( 2.64 )$$

### 5. Dynamics

### 5.1 Variable Pitch Rotors

The dynamic analysis for embodiments that use variable pitch rotors now follows. Let r₀ be the current position of a vehicle according to an embodiment and let ω_{b} be the current angular velocity such that

$${\underline{r}}_{0} = ( \begin{matrix}{x}_{0} \\ {y}_{0} \\ {z}_{0}\end{matrix} ) and {\underline{ω}}_{b} = ( \begin{matrix}{ω}_{b , x} \\ {ω}_{b , y} \\ {ω}_{b , z}\end{matrix} )$$

Also define:

$$s ( {\underline{ω}}_{b} ) = ( \begin{matrix}0 & - {ω}_{b , z} & {ω}_{b , y} \\ {ω}_{b , z} & 0 & - {ω}_{b , x} \\ - {ω}_{b , y} & {ω}_{b , x} & 0\end{matrix} ) \qquad ( 2.65 )$$

The Newton-Euler Equations (assuming negligible aerodynamic drag, which is acceptable because drag forces tend to only slow down performance but do not have any destabilising effect) give

$$\begin{matrix}{\underline{t}}_{0} = \frac{d }{d t} ( {J}_{0} {\underline{ω}}_{0} ) & ( 2.66 ) \\ ⇔ {\underline{t}}_{0} = \frac{d }{d t} ( {RJ}_{b} {R}^{T} {\underline{ω}}_{0} ) \\ since \\ {\underline{ω}}_{B}^{T} {J}_{b} {\underline{ω}}_{b} = {\underline{ω}}_{0}^{T} {RJ}_{b} {R}^{T} {\underline{ω}}_{0} = {\underline{ω}}_{0}^{T} {J}_{0} {\underline{ω}}_{0} & ( 2.67 ) \\ ⇔ {\underline{t}}_{0} = \frac{d }{d t} ( {RJ}_{b} {\underline{ω}}_{b} ) & ( 2.68 ) \\ ⇔ R {\underline{t}}_{b} = {RJ}_{b} {\dot{\underline{ω}}}_{b} + \dot{R} {J}_{b} {\underline{ω}}_{b} & ( 2.69 ) \\ ⇔ R {\underline{t}}_{b} = {RJ}_{b} {\dot{\underline{ω}}}_{b} + s ( {\underline{ω}}_{0} ) {RJ}_{b} {\underline{ω}}_{b} & ( 2.70 ) \\ ⇔ {\underline{t}}_{b} = {J}_{b} {\dot{\underline{ω}}}_{b} + {R}^{T} s ( {\underline{ω}}_{0} ) {RJ}_{b} {\underline{ω}}_{b} \\ since \\ {R}^{- 1} = {R}^{T} & ( 2.71 ) \\ ⇔ {\underline{t}}_{b} = {J}_{b} {\dot{\underline{ω}}}_{b} + s ( {\underline{ω}}_{b} ) {J}_{b} {\underline{ω}}_{b} & ( 2.72 )\end{matrix}$$

which is the torque dynamical equation in body axes.

One skilled in the art appreciates that for translational dynamics, one has:

$${\underline{f}}_{0} + ( \begin{matrix}0 \\ 0 \\ mg\end{matrix} ) = m {\ddot{\underline{r}}}_{0} \qquad ( 2.73 )$$

where m is the mass of the vehicle.

### 5.2 Variable Speed Rotors

The dynamic analysis for embodiments that use variable speed rotors now follows. Again, let r₀ be the current position of a vehicle according to an embodiment and let ω_{b} be the current angular velocity such that

$${\underline{r}}_{0} = ( \begin{matrix}{x}_{0} \\ {y}_{0} \\ {z}_{0}\end{matrix} ) and {\underline{ω}}_{b} = ( \begin{matrix}{ω}_{b , x} \\ {ω}_{b , y} \\ {ω}_{b , z}\end{matrix} )$$

Also define:

$$s ( {\underline{ω}}_{b} ) = ( \begin{matrix}0 & - {ω}_{b , z} & {ω}_{b , y} \\ {ω}_{b , z} & 0 & - {ω}_{b , x} \\ - {ω}_{b , y} & {ω}_{b , x} & 0\end{matrix} ) \qquad ( 2.74 )$$

The Newton-Euler Equations (assuming negligible aerodynamic drag, which assumption is acceptable because drag forces tend to only slow down performance but do not have any destabilising effect) are given by

$${\underline{t}}_{0} = \frac{d }{d t} ( {J}_{0} {\underline{ω}}_{0} + {RJ}_{r} [ \begin{matrix}{u}_{5} - {u}_{2} \\ {u}_{1} - {u}_{4} \\ {u}_{3} - {u}_{6}\end{matrix} ] ) \qquad ( 2.75 )$$

where Jᵣ is the scalar moment of inertia of a single rotor about its shaft or mast axis, R is the rotational matrix for transforming between body and earth axes, J₀ω₀ is the angular momentum in earth axes.

$$\begin{matrix} ⇔ R {\underline{t}}_{b} = \frac{d }{d t} ( {RJ}_{b} {\underline{ω}}_{b} + {RJ}_{r} [ \begin{matrix}{u}_{5} - {u}_{2} \\ {u}_{1} - {u}_{4} \\ {u}_{3} - {u}_{6}\end{matrix} ] ) & ( 2.76 ) \\ ⇔ R {\underline{t}}_{b} = {RJ}_{b} {\dot{\underline{ω}}}_{b} + {RJ}_{r} [ \begin{matrix}{\dot{u}}_{5} - {\dot{u}}_{2} \\ {\dot{u}}_{1} - {\dot{u}}_{4} \\ {\dot{u}}_{3} - {\dot{u}}_{6}\end{matrix} ] + \dot{R} {J}_{b} {\underline{ω}}_{b} + \dot{R} {J}_{r} [ \begin{matrix}{u}_{5} - {u}_{2} \\ {u}_{1} - {u}_{4} \\ {u}_{3} - {u}_{6}\end{matrix} ] & ( 2.77 ) \\ ⇔ {\underline{t}}_{b} = \{ {J}_{b} {\dot{\underline{ω}}}_{b} + {J}_{r} [ \begin{matrix}{\dot{u}}_{5} - {\dot{u}}_{2} \\ {\dot{u}}_{1} - {\dot{u}}_{4} \\ {\dot{u}}_{3} - {\dot{u}}_{6}\end{matrix} ] \} + {R}^{T} s ( {\underline{ω}}_{0} ) R \{ {J}_{b} {\underline{ω}}_{b} + {J}_{r} [ \begin{matrix}{u}_{5} - {u}_{2} \\ {u}_{1} - {u}_{4} \\ {u}_{3} - {u}_{6}\end{matrix} ] \} & ( 2.78 ) \\ ⇔ {\underline{t}}_{b} = \{ {J}_{b} {\dot{\underline{ω}}}_{b} + {J}_{r} [ \begin{matrix}{\dot{u}}_{5} - {\dot{u}}_{2} \\ {\dot{u}}_{1} - {\dot{u}}_{4} \\ {\dot{u}}_{3} - {\dot{u}}_{6}\end{matrix} ] \} + s ( {\underline{ω}}_{b} ) \{ {J}_{b} {\underline{ω}}_{b} + {J}_{r} [ \begin{matrix}{u}_{5} - {u}_{2} \\ {u}_{1} - {u}_{4} \\ {u}_{3} - {u}_{6}\end{matrix} ] \} & ( 2.79 )\end{matrix}$$

Since in practice J_{b} will typically be several orders of magnitude larger than Jᵣ, then gyroscopic effects will have negligible effect on the dynamics and hence can be safely ignored. Additionally, even when this assumption is not fulfilled, gyroscopic effects tend to have a stabilising effect on attitude due to conservation of angular momentum rather than a detrimental effect. Consequently, henceforth, it will be assumed that:
1. J_{b}ω_{b} is greater (component-wise) than

$${J}_{r} [ \begin{matrix}{u}_{5} - {u}_{2} \\ {u}_{1} - {u}_{4} \\ {u}_{3} - {u}_{6}\end{matrix} ]$$

2. J_{b}\dot{ω}_{b} is greater (component-wise) than

$${J}_{r} [ \begin{matrix}{\dot{u}}_{5} - {\dot{u}}_{2} \\ {\dot{u}}_{1} - {\dot{u}}_{4} \\ {\dot{u}}_{3} - {\dot{u}}_{6}\end{matrix} ]$$

so that gyroscopic effects can be ignored to give:

t_{b}=J_{b}\dot{ω}_{b}+s(ω_{b})J_{b}ω_{b} (2.80)

Considering translational dynamics gives:

$${\underline{f}}_{0} + ( \begin{matrix}0 \\ 0 \\ mg\end{matrix} ) = m {\ddot{\underline{r}}}_{0} where m is the mass of the vehicle . \qquad ( 2.81 )$$

### 6. Translational Control

Translation control of embodiments of the present invention are governed by the following. Consider a desired force

$$( \begin{matrix}{v}_{1} \\ {v}_{2} \\ {v}_{3}\end{matrix} )$$

or thrust for the vehicle expressed as follows:

$$( \begin{matrix}{v}_{1} \\ {v}_{2} \\ {v}_{3}\end{matrix} ) = - ( \begin{matrix}0 \\ 0 \\ mg\end{matrix} ) + m [ {\ddot{\underline{r}}}_{0}^{d} - 2 ξ c ( {\dot{\underline{r}}}_{0} - {\dot{\underline{r}}}_{0}^{d} ) - {c}^{2} ( {\underline{r}}_{0} - {\underline{r}}_{0}^{d} ) ] \qquad ( 2.82 )$$

which gives the following closed loop translational dynamics

(\ddot{r}₀−\ddot{r}₀^{d})+2ξc(\dot{r}−\dot{r}₀^{d})+c²(r₀−r₀^{d})=0 (2.83)

where \ddot{r}₀^{d} is a desired acceleration, \dot{r}₀^{d} is a desired velocity and r₀^{d} is a desired position of the desired trajectory, ξ is the damping factor and c is the natural frequency (related to the time-constant).

Embodiments can be realised in which ξ=0.7 and c=2π(0.2) to achieve acceptable closed-loop pole placement. For a stable system the poles are preferably in the left-hand plane of the Argand (i.e. pole-zero) diagram. However, one skilled in the art appreciates that the pole positions can be varied according to desired performance characteristics.

If the weight vector is not perfectly cancelled and leaves a residue of

$$( \begin{matrix}0 \\ 0 \\ β\end{matrix} )$$

and if additionally if there is also a drag, γ\dot{r}₀, then the transfer function from input to output is:

$${\underline{r}}_{0} ( s ) = ( \frac{{s}^{2} + 2 ξ cs + {c}^{2}}{{s}^{2} + ( 2 ξ c + \frac{γ}{m } ) s + {c}^{2}} ) {\underline{r}}_{0}^{d} ( s ) + \frac{1}{s [ {s}^{2} + ( 2 ξ c + \frac{γ}{m} ) s + {c}^{2} ]} ( \begin{matrix}0 \\ 0 \\ β / m\end{matrix} ) \qquad ( 2.84 )$$

If r₀^{d}(s) is a step on one of the input channels (i.e. in one of the elements of the input vector r₀^{d}(s)), then

$${\underline{r}}_{0} ( ∞ ) = {lim}_{t \to ∞} {\underline{r}}_{0} ( t ) = {lim}_{s \to ∞} s \cdot {\underline{r}}_{0} ( s ) = {\underline{r}}_{0}^{d} + ( \begin{matrix}0 \\ 0 \\ {β}^{2} / {m}^{2}\end{matrix} ) \qquad ( 2.85 )$$

This is acceptable steady-state behaviour for the above postulated mismatches.

### 7. Rotational Control

Let

$$( \begin{matrix}{v}_{4} \\ {v}_{5} \\ {v}_{6}\end{matrix} )$$

be desired torques of a vehicle according to an embodiment, which are given by

$$( \begin{matrix}{v}_{4} \\ {v}_{5} \\ {v}_{6}\end{matrix} ) = s ( {\underline{ω}}_{b} ) {J}_{b} {\underline{ω}}_{b} + d {J}_{b} ( {\underline{ω}}_{b}^{reference} - {\underline{ω}}_{b} ) \qquad ( 2.86 )$$

where
d determines the closed-loop time constant, (see (2.87) below why this is indeed the case). The particular embodiment has d=2π(0.2) for a 5 second time so that the following closed-loop angular velocity dynamics are:

\dot{ω}_{b}+dω_{b}=dω_{b}^{reference} (2.87)

and ω_{b}^{reference} is the required reference trajectory for the body axes angular velocity. Now define a normalised error attitude quaternion q^{e} to be given by:

q^{e}=(q^{d}·q*) (2.88)

where q^{d} represents a desired vehicle attitude and q* is the quaternion conjugate of the current vehicle attitude.

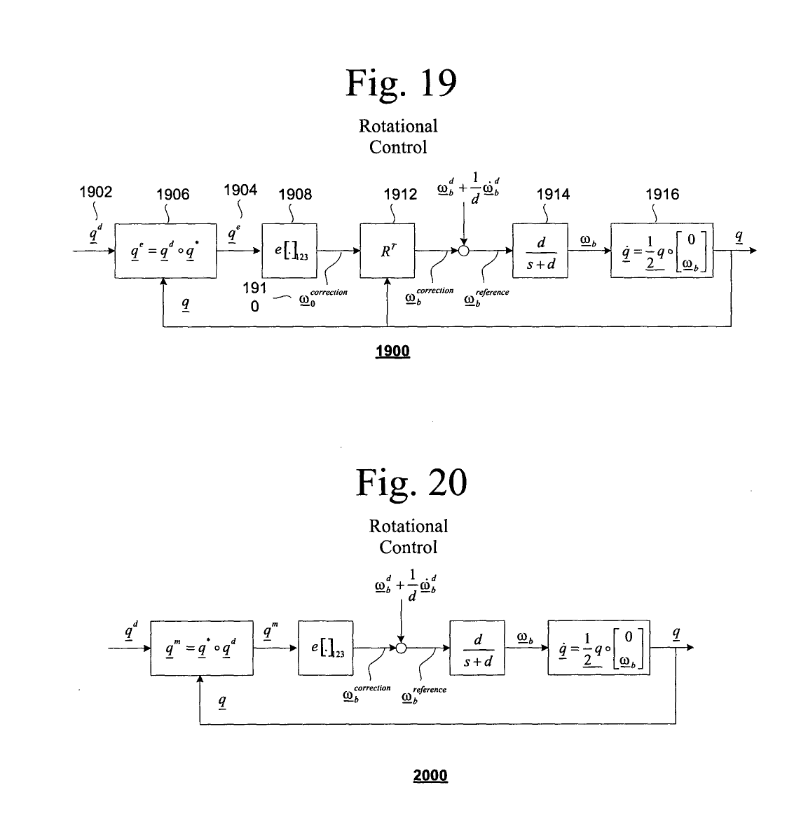

Therefore, one skilled in the art will appreciate that an attitude/rotational feedback control system 1900 can be realised as shown in FIG. 19. A desired position q^{d} 1902 expressed as a quaternion is an input to the control system 1900. The normalised quaternion error attitude 1904 is calculated by a block implementing equation 2.88. The vector part of the normalised error attitude quaternion is extracted at block 1908 to produce a desired correction of angular velocity, ω₀^{correction}, 1910 expressed in earth axes, which is transformed into body coordinates by R^{T} in block 1912 to give a desired angular velocity, ω_{b}^{correction}, 1910 expressed in body axes. The desired angular velocity correction, ω_{b}^{correction}, expressed in body axes, is combined with closed loop angular velocity dynamics, expressed in equation 2.87 above, to produce a reference angular velocity, ω_{b}^{reference}, which is process by block 1914 to produce the vehicle's current angular velocity, ω_{b}, expression in body axes. The vehicle's current angular velocity, ω_{b}, is processed by block 1916, which implements equation 2.64, to produce a quaternion expressing the current position/attitude, q, of the vehicle.

Defining a mismatch normalised quaternion q^{m} by

q^{m}=q*·q^{d},

one skilled in the art appreciates that since

$$\underline{q} \cdot ( \begin{matrix}δ \\ \underline{n}\end{matrix} ) \cdot {\underline{q}}^{*} = ( \begin{matrix}δ \\ R \underline{n}\end{matrix} ) \qquad ( 2.89 )$$

for any arbitrary real scalar δ and any arbitrary vector n, it follows that

$$\begin{matrix}{\underline{q}}^{m} = {\underline{q}}^{*} \cdot {\underline{q}}^{d} = {\underline{q}}^{*} \cdot {\underline{q}}^{d} \cdot {\underline{q}}^{*} \cdot \underline{q} & ( 2.90 ) \\ = {\underline{q}}^{*} \cdot {\underline{q}}^{e} \cdot \underline{q} & ( 2.91 ) \\ = {\underline{q}}^{*} \cdot ( \begin{matrix}δ \\ \underline{n}\end{matrix} ) \cdot \underline{q} & ( 2.92 ) \\ = ( \begin{matrix}δ \\ {R}^{T} \underline{n}\end{matrix} ) & ( 2.93 )\end{matrix}$$

so that

[q^{m}]₁₂₃=R^{T}[q^{e}]₁₂₃

Therefore, FIG. 19 can be simplified as indicated in 2000 expressed in FIG. 20.

### 8. Stability Analysis of Attitude and Angular Velocity Control

A stability analysis for the above attitude and angular velocity control will be given below.

Let the Lyapunov function V be defined as:

$$V = \frac{{( {\underline{ω}}_{b} - {\underline{ω}}_{b}^{d} )}^{T} ( {\underline{ω}}_{b} - {\underline{ω}}_{b}^{d} )}{2 d} + e ( {[ {\underline{q}}^{m} ]}_{1}^{2} + {[ {\underline{q}}^{m} ]}_{2}^{2} + {[ {\underline{q}}^{m} ]}_{3}^{2} + {( {[ {\underline{q}}^{m} ]}_{0} - 1 )}^{2} ) \qquad ( 2.94 )$$

Note that V≧0∀ω_{b}, q^{m} and V=0 if and only if ω_{b}=ω_{b}^{d} and q=q^{d}.

Since ∥q^{m}∥=1, V can be re arranged as:

$$V = \frac{{( {\underline{ω}}_{b} - {\underline{ω}}_{b}^{d} )}^{T} ( {\underline{ω}}_{b} - {\underline{ω}}_{b}^{d} )}{2 d} + 2 e ( 1 - {[ {\underline{q}}^{m} ]}_{0} ) \qquad ( 2.95 )$$

Therefore,

$$\begin{matrix} \dot{V} = {( {\underline{ω}}_{b} - {\underline{ω}}_{b}^{d} )}^{T} ( \frac{{{ω}_{\_}^{.}}_{b}}{d} - \frac{{{ω}_{\_}^{.}}_{b}^{d}}{d} ) - 2 {e [ {{q}_{\_}^{.}}^{m} ]}_{0} & ( 2.96 ) \\ ⇒ \dot{V} = {( {\underline{ω}}_{b} - {\underline{ω}}_{b}^{d} )}^{T} ( - {\underline{ω}}_{b} + {\underline{ω}}_{b}^{reference} - \frac{{{ω}_{\_}^{.}}_{b}^{d}}{d} ) - 2 {e [ {{q}_{\_}^{.}}^{m} ]}_{0} & ( 2.97 ) \\ ⇒ \dot{V} = {( {\underline{ω}}_{b} - {\underline{ω}}_{b}^{d} )}^{T} ( - {\underline{ω}}_{b} + {e [ {\underline{q}}^{m} ]}_{123} + {\underline{ω}}_{b}^{d} ) - 2 {e [ {{q}_{\_}^{.}}^{m} ]}_{0} & ( 2.98 ) \\ ⇒ \dot{V} = - {( {\underline{ω}}_{b} - {\underline{ω}}_{b}^{d} )}^{T} ( {\underline{ω}}_{b} + {\underline{ω}}_{b}^{d} ) + {{e ( {\underline{ω}}_{b} - {\underline{ω}}_{b}^{d} )}^{T} [ {\underline{q}}^{m} ]}_{123} - 2 {e [ {{q}_{\_}^{.}}^{m} ]}_{0} & ( 2.99 )\end{matrix}$$

Therefore, \dot{V}<0 ∀ω_{b}≠ω_{b}^{d} since (ω_{b}−ω_{b}^{d})^{T}[q^{m}]₁₂₃−2[\dot{q}^{m}]₀=0 (2.100)

The latter fact is because

q^{m}=q*·q^{d} and [q^{m}]₀=q^{T}q^{d} (2.101)

Therefore

$$\begin{matrix}{[ {{q}_{\_}^{.}}^{m} ]}_{0} = {\underline{q}}^{T} {{q}_{\_}^{.}}^{d} + {( {\underline{q}}^{d} )}^{T} {q}_{\_}^{.} & ( 2.102 ) \\ = {[ {\underline{q}}^{*} \cdot {{q}_{\_}^{.}}^{d} ]}_{0} + {[ {( {\underline{q}}^{d} )}^{*} \cdot {q}_{\_}^{.} ]}_{0} & ( 2.103 ) \\ = {\frac{1}{2} [ {\underline{q}}^{*} \cdot {\underline{q}}^{d} \cdot [ \begin{matrix}0 \\ {\underline{ω}}_{b}^{d}\end{matrix} ] ]}_{0} + {\frac{1}{2} [ {\underline{q}}^{d *} \cdot \underline{q} \cdot [ \begin{matrix}0 \\ {\underline{ω}}_{b}\end{matrix} ] ]}_{0} & ( 2.104 ) \\ = {\frac{1}{2} [ {\underline{q}}^{m} \cdot [ \begin{matrix}0 \\ {\underline{ω}}_{b}^{d}\end{matrix} ] ]}_{0} + {\frac{1}{2} [ {\underline{q}}^{m *} \cdot [ \begin{matrix}0 \\ {\underline{ω}}_{b}\end{matrix} ] ]}_{0} & ( 2.105 ) \\ = - \frac{1}{2} {{( {\underline{ω}}_{b}^{d} )}^{T} [ {\underline{q}}^{m} ]}_{123} + \frac{1}{2} {{\underline{ω}}_{b}^{T} [ {\underline{q}}^{m} ]}_{123} & ( 2.106 ) \\ = \frac{1}{2} {{( {\underline{ω}}_{b} - {\underline{ω}}_{b}^{d} )}^{T} [ {\underline{q}}^{m} ]}_{123} & ( 2.107 )\end{matrix}$$

One skilled in the art will appreciate that V(t) gets stuck at an equipotential wherever ω_{b}(t)=ωω_{b}^{d}(t)∀t since \dot{V}(t)=0. Now it will be shown that ω_{b}(t)=ω_{b}^{d}(t)∀t [symbol] =q(t)=q^{d}(t)∀t and, consequently, such an equipotential corresponds to V(t)=0, which is a desired equilibrium.

$$\begin{matrix}{\underline{ω}}_{b} ( t ) = {\underline{ω}}_{b}^{d} ( t ) ∀ t & ( 2.108 ) \\ ⇒ {{ω}_{\_}^{.}}_{b} ( t ) = {{ω}_{\_}^{.}}_{b}^{d} ( t ) ∀ t & ( 2.109 ) \\ ⇒ {ω}_{b}^{correction} ( t ) = 0 via {\underline{ω}}_{b} + d {\underline{ω}}_{b} = d {\underline{ω}}_{b}^{reference} . & ( 2.110 ) \\ ⇒ {\underline{q}}^{m} ( t ) = ( \begin{matrix}1 \\ 0 \\ 0 \\ 0\end{matrix} ) & ( 2.111 ) \\ ⇒ \underline{q} ( t ) = {\underline{q}}^{d} ( t ) & ( 2.112 )\end{matrix}$$

### 9. Trajectory Planning

One skilled in the art appreciates that

$${{q}_{\_}^{.}}^{d} = \frac{1}{2} {\underline{q}}^{d} \cdot [ \begin{matrix}0 \\ {\underline{ω}}_{b}^{d}\end{matrix} ] \qquad ( 2.113 )$$

which gives

$$[ \begin{matrix}0 \\ {\underline{ω}}_{b}^{d}\end{matrix} ] = 2 {\underline{q}}^{d *} \cdot {{q}_{\_}^{.}}^{d} \qquad ( 2.114 )$$

then

$$[ \begin{matrix}0 \\ {{ω}_{\_}^{.}}_{b}^{d}\end{matrix} ] = 2 {\underline{q}}^{d *} \cdot {{q}_{\_}^{¨}}^{d} + 2 {{q}_{\_}^{.}}^{d *} \cdot {{q}_{\_}^{.}}^{d} \qquad ( 2.115 )$$

so that

$$[ \begin{matrix}0 \\ {{ω}_{\_}^{.}}_{b}^{d}\end{matrix} ] = 2 {\underline{q}}^{d *} \cdot {{q}_{\_}^{¨}}^{d} + 2 ( \begin{matrix}{‖ {{q}_{\_}^{.}}^{d} ‖}^{2} \\ 0 \\ 0 \\ 0\end{matrix} ) \qquad ( 2.116 )$$

thereby giving

$$[ \begin{matrix}0 \\ {{ω}_{\_}^{.}}_{b}^{d}\end{matrix} ] = 2 {\underline{q}}^{d *} \cdot {{q}_{\_}^{¨}}^{d} + \frac{1}{2} ( \begin{matrix}{‖ {\underline{ω}}_{b}^{d} ‖}^{2} \\ 0 \\ 0 \\ 0\end{matrix} ) \qquad ( 2.117 )$$

that is:
Angular position q^{d}
Angular Velocity ω_{b}^{d}=2[q^{d}* ·\dot{q}^{d}]₁₂₃
Angular acceleration \dot{ω}_{b}^{d}=2[q^{d}* ·\ddot{q}^{d}]₁₂₃

The above described control systems also supports a ground or, more generally, a surface mode of locomotion by providing torque about the contact point between an airframe and the surface. The surface might be, for example, the ground, a roof, a wall, a ceiling etc.

Referring to FIG. 21 there is shown a preferred embodiment of a vehicle that also has a ground or surface mode of locomotion. It can be appreciated that the vehicle comprises a number of rims 2102 to 2108 that define a spherical frame that can be used for rolling.

It will be appreciated that rolling is different to air borne flight in that during rolling the weight of the vehicle is supported by a ground reaction force. Translation control is similar in both cases in that a force vector in the required direction of motion is applied to the vehicle centre of gravity. However, during rolling, friction between the ground and the vehicle causes a torque about the centre of gravity and causes the rotation associated with rolling (with no friction the vehicle will slide instead of rolling).

A challenge in implementing rolling control is that of synthesising a correct attitude demand as the vehicle rolls along. The correct attitude is defined as when the plane of the wheel is aligned with gravity and also aligned with vehicle ground velocity vector. This means the wheel is ‘upright’ and that the torque vector due to ground friction is normal to the plane of the wheel (i.e. friction causes the wheel to rotate about its axis, which is equivalent to the ‘no tyre scrubbing’ condition). As the ground velocity vector tends to zero it is necessary to reduce the velocity alignment attitude to identity so that the vehicle remains steady and upright when not moving.

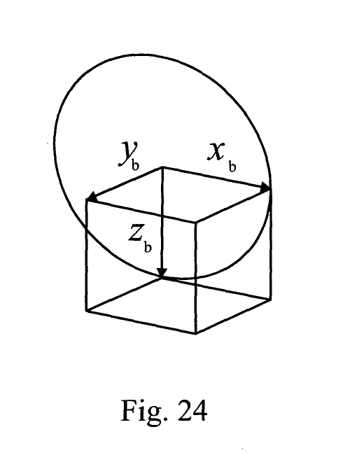

FIGS. 24, 25 and 26 illustrate the rotation steps to synthesise the correct attitude demand for the vehicle attitude control system. The basic structure of the attitude control system will be the same as for the flight vehicle case. However, the vehicle dynamics will be different due to the influence of the contact point with ground.

FIG. 24 depicts the definition of a generic wheel with initial body axes aligned with the Earth axes. Axis yb is normal to the plane of the wheel and axis zb is aligned with the local gravity vector (ze).

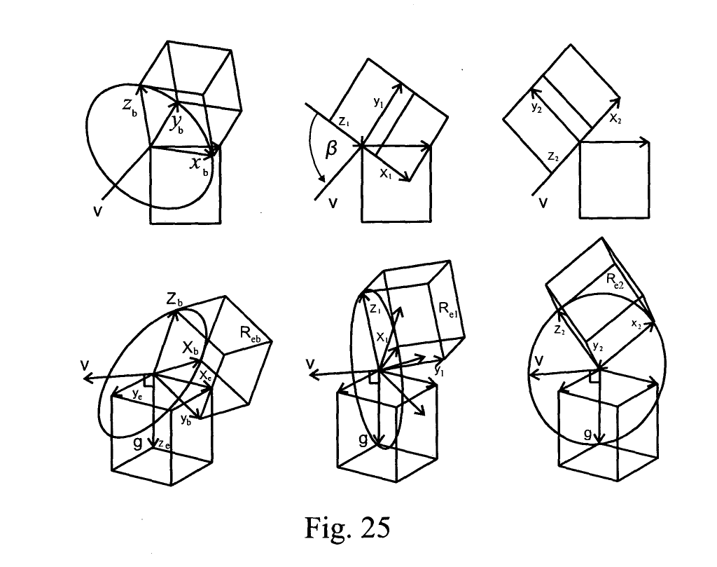

FIG. 25 illustrates steps to correctly synthesize attitude demand for a rolling vehicle. A wheel at an arbitrary attitude 1) is first orientated such that wheel disc is aligned with the local gravity vector by rotating around the point of contact of the wheel with the ground 2). The wheel is then rotated about the gravity vector to align the wheel disc with the ground velocity vector.

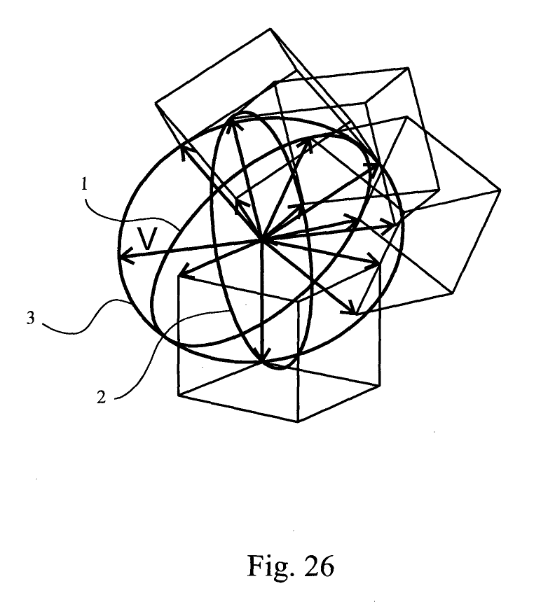

FIG. 26 depicts superposition of the three rotation states illustrated in FIG. 25.

A further advantage of the vehicle having a frame that is outwardly disposed relative to the rotors is that the torque and thrust vectoring can be used to press the vehicle against a surface, which enables hovering with reduced thrust (and hence reduced power consumption) to be realised due to frictional coupling with the surface to assist in supporting the weight of the vehicle. In the case of a vertical wall and a component of at least one of thrust and torque being normal to the wall, the forces required to hover freely and to hover when the vehicle is frictionally coupled to the wall are given by

$${\underline{F}}_{free\_hover} = m \underline{g} and {\underline{F}}_{wall} = \frac{m \underline{g}}{\sqrt{( 1 + {μ}^{2} )}} respectively ,$$

where μ is the coefficient of friction.

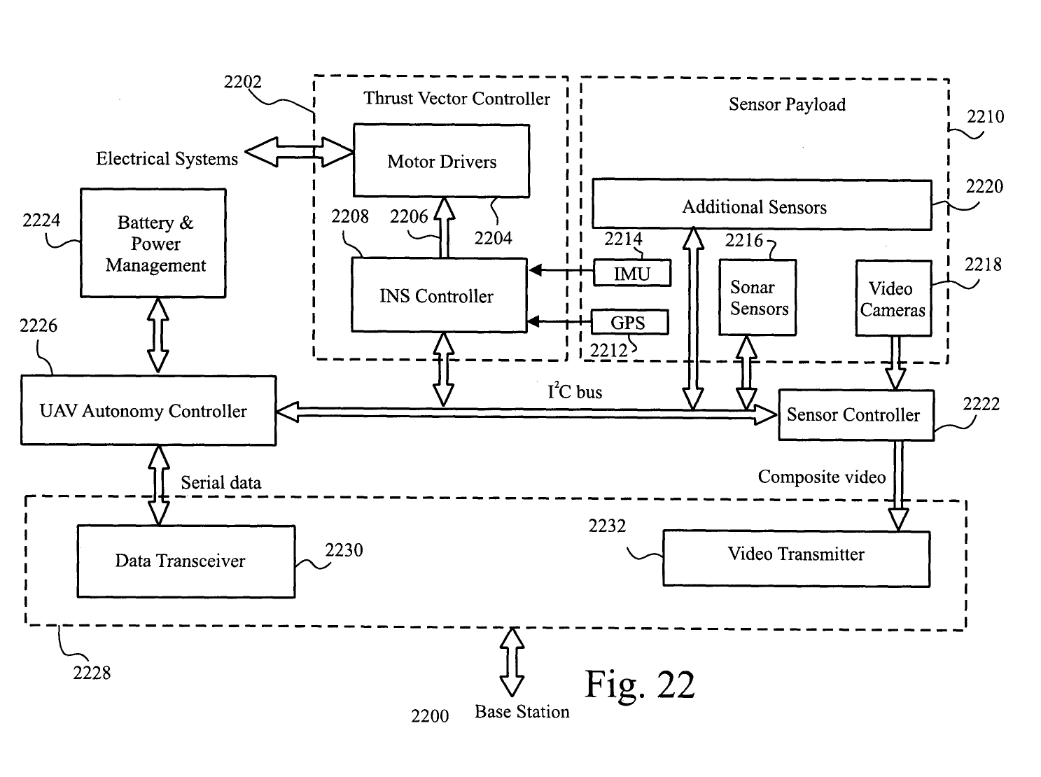

FIG. 22 shows a schematic view 2200 of the communication and control system. The communication and control system 2200 comprises a number of distinct subsystems. A thrust vector controller 2202 is provided to drive the rotors, via motor drivers 2204, in response to data 2206 received from an inertial navigation system (INS) controller 2208. A sensor payload subsystem 2210 is arranged to contain one or more than one sensor. In the illustrated embodiment, a GPS system 2212 is used to provide GPS data to the INS controller 2208. Similarly, an inertial measurement unit 2214 provides data to the INS 2208. The thrust vector controller 2202 comprises an embedded controller that is used to implement a six axis inertial navigation system.

Optionally, the sensor payload subsystem 2210 may additionally comprise a sonar sensor subsystem 2216 that is used, primarily, for proximity measurements used for obstacle or ground detection. Still further, the sensor payload subsystem 2210 may additionally or alternatively comprise one or more than one video camera subsystem 2218. A preferred embodiment of the present invention comprises one or more than one video camera having a fixed attitude or orientation relative to the vehicle reference plane. Additional or alternative sensors may be accommodated in the sensor payload subsystem 2210 as can be appreciated from FIG. 22, which shows additional sensors 2220.

A sensor controller 2222 is provided to manage the operation of the sensors forming part of the sensor payload subsystem 2210.

A battery and power management system 2224 is provided to supply the power needed to power the various subsystems shown in FIG. 22. Preferably, a small rechargeable battery is used to power the vehicle's electronics. Power for the vehicle's electronics is separate to the supply that is used for the rotors and motors to reduce the risk of failure due to electrical noise. The autonomy controller 2226 is arranged to monitor both its own supply and the supply of the motors with a view to automatically returning to base or performing a controlled landing in the event of a sufficiently depleted supply.

A UAV autonomy controller 2226 is used to manage the operation of all of the subsystems shown in FIG. 22. The UAV autonomy controller 2226 is responsible for tasks such as hosting the communications protocol stack, flight plan management including waypoint and pose dispatch, sensor data collection, collision avoidance, systems monitoring and failsafe control.

Finally, a communication subsystem 2228 is used to receive telemetry, command and control information from a remote control base station (not shown) via a data transceiver 2230. A video transmitter 2232 is arranged to transmit video data supplied by the one or more than one video camera 2218 to the remote control base station or to any other designated receiver.

Referring to FIGS. 23(a) to (c), there is shown an number of views 2300 of arrangements of rotors and rotor disc planes. One skilled in the art will recognise that the views illustrated in FIGS. 23(a) to (c) correspond to those shown in and described with reference to FIGS. 5, 6 and 7. The centres of the rotors are all at a distance a from at least one axis of the xyz vehicle axes.

Although embodiments of the invention have been separately described with reference to variable pitch angle and variable rotor speeds, vehicles according to the invention are not limited thereto. Embodiments can be realised that use a combination of variable pitch and variable rotor speed.

Embodiments of the invention have been described with reference to each rotor having a respective motor. However, embodiments are not limited to such arrangements. Embodiments can be realised in which fewer motors, preferable one, than there are rotors are used together with a transmission mechanism for driving the rotors using the fewer motors or using the single motor. Preferably, the transmission mechanism could be geared to allow at least one of the spin direction and angular velocity of the rotors to be controllable independently.

It will be appreciated from the above that embodiments of the present invention have impressive performance in which the vehicle can fly with an arbitrarily selectable attitude due to the thrust vectoring.

Embodiments of the present invention provide 6 degrees of freedom to support arbitrary 3D thrust and/or torque vectoring. Still further impressive flight performance characteristics are that the thrust and torque vectoring are operable independently so that, for example, control over torque vectoring can be maintained simultaneously with control over thrust vectoring and vice versa.

The embodiments described above have been realised using electric propulsion. However, embodiments are not limited thereto. Embodiments can be realised using one or more than one liquid fuelled turbine or internal combustion engine, which will have an improved specific energy density. However, one skilled in the art will realised that the dynamics of the vehicle will change as the total mass changes due to fuel depletion.

Embodiments of the invention are adapted to allow at least one of arbitrarily orientable thrust vector (that is, an arbitrarily selectable or desired direction of the thrust vector) and arbitrarily orientable torque vector (that is, an arbitrarily selectable or desired direction of the torque vector) for the vehicle while concurrently supporting the weight of the vehicle. One skilled in the art will appreciate that supporting the weight of the vehicle includes supporting that weight during hovering or flight in any direction. The flight can be also be at an arbitrarily selectable velocity.

The control system for the vehicle is adapted so that the rotors can be arranged to maintain reduced, and preferably, zero net angular momentum between selected rotors such as, for example, pairs of rotors in the same plane, when desired.

Embodiments of the invention encompass a vehicle as described herein together with a tether such as disclosed in U.S. patent application Ser. No. 12/017,537 (publication number 20080300821); the contents of which are incorporated herein for all purposes.

Embodiments of the present invention advantageously, and optionally, employ an airframe that is collapsible or modular. A collapsible or modular structure greatly improves the packing density of the vehicle. This has the advantage that the vehicle is more conveniently portable and can be readily deployed, for example, with theatre in a battle situation or more readily carried within the boot of a car for police or other surveillance situations.

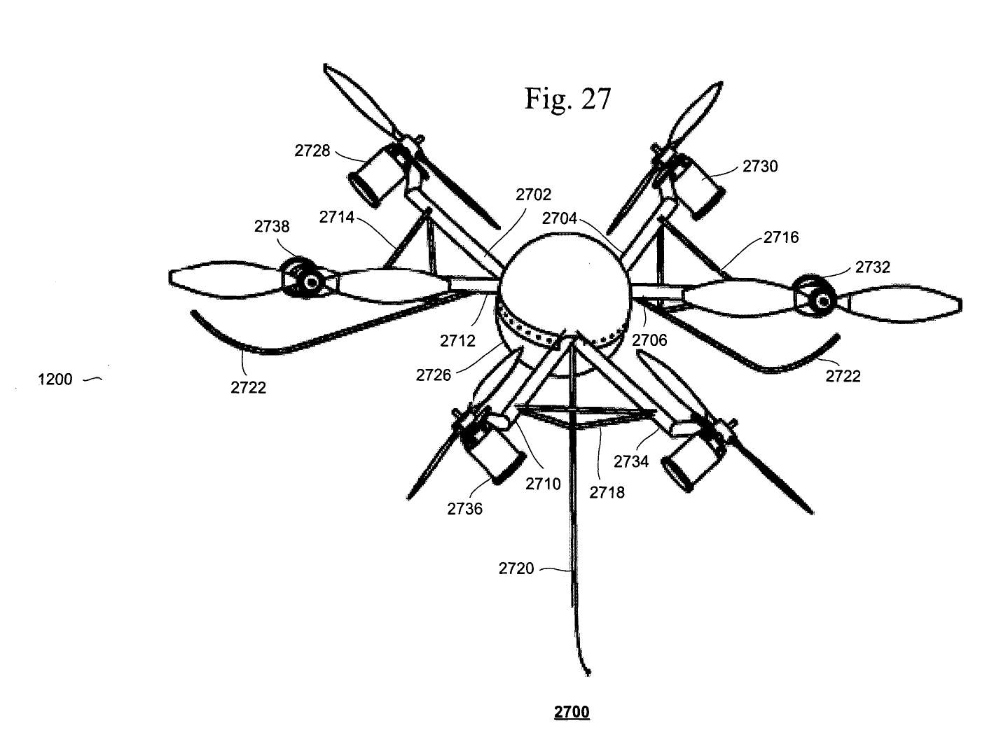

Referring to FIG. 27, there is shown an embodiment of a modular airframe 2700.

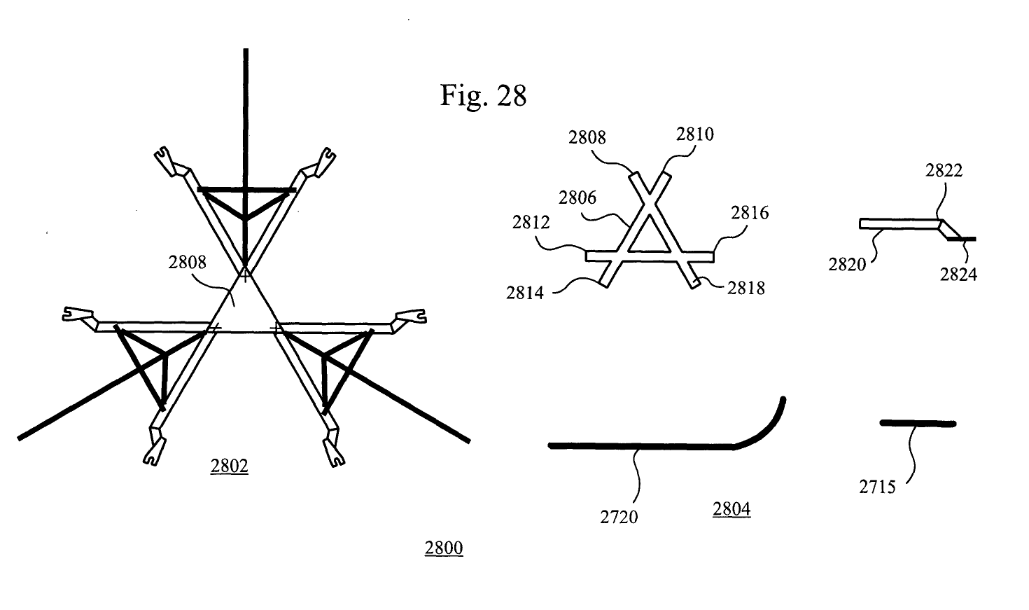

The airframe 2700 comprises a number of support struts 2702 to 2712. The support struts 2702 to 2712 bear a number of respective leg braces 2714 to 2718, each, in turn, bearing a respective leg 2720 to 2724. The support struts depend from a system housing 2726. The vehicle housing 2726 contains the vehicle's systems, as illustrated in and described with reference to, for example, FIG. 22. Each support strut 2702 to 2712 also bears a respective motor 2728 to 2738, as described earlier. Clearly, each motor 2728 to 2736 is used to drive respective rotors, which have not been labelled in the interests of clarity. The vehicle housing 2726 also houses a mounting plate shown in FIG. 28 on which the vehicle's systems can be mounted.

The modules are connected to one another using respective mechanical electrical and electrical connectors.

It will be appreciated that the support struts 2702 to 2712, leg braces 2714 to 2718 and legs 2720 to 2724 represent the most inefficient components for packaging. Suitably, embodiments are provided in which the support struts 2702 to 2712, legs 2720 to 2724 and leg braces 2715 to 2718 can be disassembled.

Referring to FIG. 28, there is shown an illustration 2800 of an embodiment in an assembled 2802 and in a disassembled 2804 state. The embodiment comprises a central hub 2806. Preferably, the central hub 2806 bears the above mentioned support plate 2808. It can be appreciated that the legs 2720 to 2724 form separable elements of the vehicle airframe 2700. A single leg 2720 is illustrated for the purposes of clarity. Similarly for the leg braces 2715 to 2718; a single one 2715 of which is shown. Each of the support struts 2702 to 2712 is formed from a respective limb 2808 to 2818 of the central hub 2806 and a respective boom 2820; only one of the six booms used by the embodiment is illustrated. Each boom 2820 has an angled portion 2822 that bears a mount 2824 a respective motor. The booms are connected to the limbs 2808 to 2818 such that the rotors are angled upwards, that is, away from the legs.

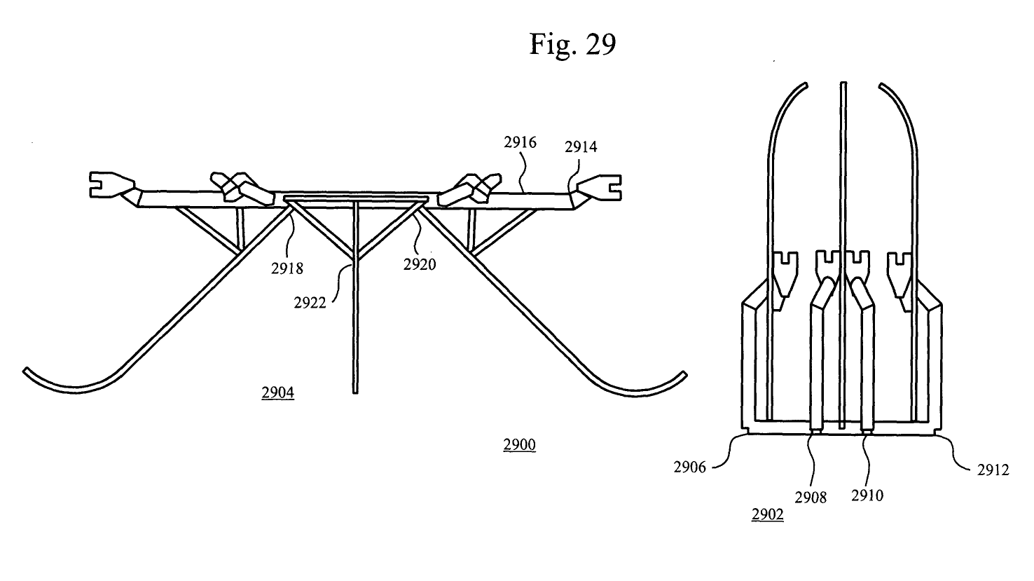

FIG. 29 depicts an embodiment of an airframe 2900 that is capable of being folded, that is, is has a stowed state 2902 and a deployed state 2904. It can be appreciated that the booms are connected to the limbs via respective hinges; only four of the six boom-limb hinges 2906 to 2912 are depicted. The hinges are arranged such that they can be locked in position in the deployed state. Optionally, the booms are locked in position in the stowed state. The boom arms are preferably rotated about respective longitudinal axes (not shown) thereof such that the angled portions and mounts are inwardly directed. Using one boom as an example, preferably the rotation is effected about point 2914. The same applies in respect of each boom. The boom-limb hinges are preferably disposed at point 2916 for each boom-limb pair. Preferably, the leg braces can detached from points 2918 and 2920. Preferably, the legs braces are coupled to respective legs via respective hinges such as a hinge at point 2922. In preferred embodiments, the leg braces form a triangular brace with a vertex of the triangle being adapted for connection at point 2922; the other vertices being adapted for connection at points 2918 and 2920. In preferred embodiments, the legs braced are connected to the respective legs to allow them to be substantially parallel with the legs in the stowed position. Similarly, the part of the leg brace that spans adjacent limbs or booms is connected via a hinge to one of a respective limb or boom and is disposed substantially parallel to the respective limb or boom in the stowed position.

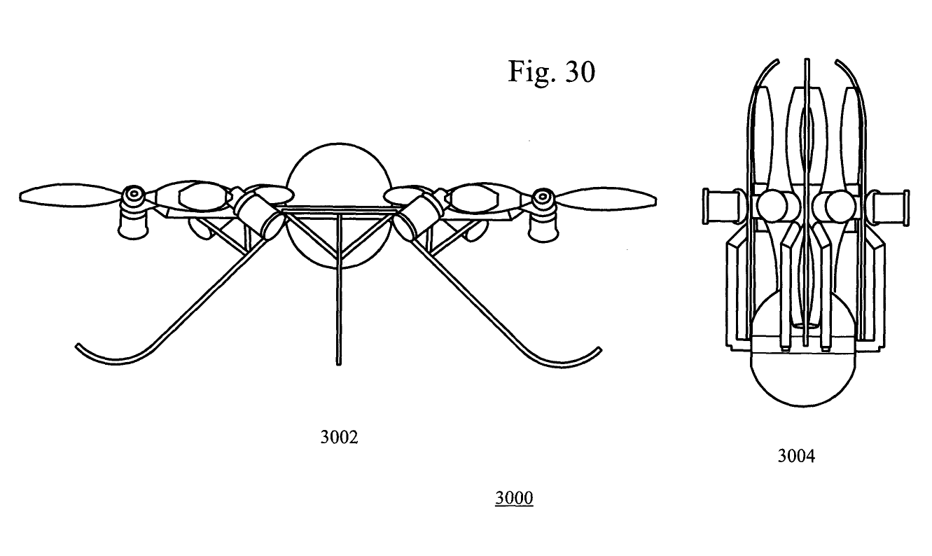

FIG. 30 shows a preferred embodiment of the collapsible or foldable airframe 3000. The airframe, indeed the vehicle itself, has a stowed state 3002 and a deployed state 3004. The airframe 3000 has much in common with the airframe 2900 described with reference to and illustrated in FIG. 29, with the addition that a system housing 3004 and the rotors remain attached in the stowed state 3002.

It will be appreciated that the hinges or otherwise jointed nature of the above embodiments can be realised in a number of ways. For example, embodiments can used hinges or poles coupled by springs, with the ends of the poles being adapted such that they interlock via, for example, differing diameters.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A rotary wing vehicle comprising
a plurality of rotors for rotation within respective rotation planes wherein at least two of the rotation planes are inclined relative to one another,
a body bearing the plurality of rotors in a fixed relationship to the body; the vehicle comprising a control system for controlling the rotors;
wherein the plurality of rotors have one or more than one motor for rotating the rotors to produce respective rotor thrust vectors wherein the control system controls the plurality of rotors to produce an arbitrary selectable or desired net thrust vector; and
the plurality of rotors have one or more than one motor for rotating the rotors to produce respective rotor thrust vectors wherein the control system controls the plurality of rotors to produce an arbitrary selectable or desired torque vector.

2-31. (canceled)

32. A rotary wing vehicle as claimed in claim 1 in which the plurality of rotors comprises a plurality of pairs of rotors wherein the rotation planes of the rotors in each pair of rotors are coplanar.

33. A rotary wing vehicle as claimed in claim 1 in which the plurality of rotors have respective axes of rotation and the points of intersection of the axes of rotation with respective planes are coplanar.

34. A rotary wing vehicle as claimed in claim 1 in which the plurality of rotors have respective axes of rotation and at least two of the points of intersection of the axes of rotation with respective rotation planes are non-coplanar.

35. A rotary wing vehicle as claimed in claim 1 in which the plurality of rotors have one or more than one motor for rotating the rotors to produce respective rotor thrust vectors wherein the control system controls the plurality of rotors to produce an arbitrary selectable or desired net thrust vector relative a first frame of reference fixed relative to the vehicle while maintaining a fixed vehicle attitude of the first frame of reference relative to a second frame of reference.

36. A rotary wing vehicle as claimed in claim 1 in which the control system controls the plurality of rotors to produce an arbitrary selectable or desired net thrust vector by varying the respective pitches of the blades of the rotors.

37. A rotary wing vehicle as claimed in claim 1 in which the control system controls the plurality of rotors to produce an arbitrary selectable or desired net thrust vector by varying the respective angular velocities of the rotors.

38. A rotary wing vehicle as claimed in claim 1 in which the control system controls the plurality of rotors to produce an arbitrary selectable or desired net thrust vector by varying the respective spin directions of the rotors.

39. A rotary wing vehicle as claimed in claim 1 in which the plurality of rotors have one or more than one motor for rotating the rotors to produce respective rotor thrust vectors wherein the control system controls the plurality of rotors to produce the arbitrary selectable or desired torque vector relative a first frame of reference fixed relative to the vehicle while maintaining a fixed vehicle attitude for the first frame of reference relative to a second frame of reference.

40. A rotary wing vehicle as claimed in claim 1 in which the control system controls the plurality of rotors to produce an arbitrary selectable or desired torque vector by varying the respective pitches of the blades of the rotors.

41. A rotary wing vehicle as claimed in claim 1 in which the control system controls the plurality of rotors to produce an arbitrary selectable or desired torque vector by varying the respective angular velocities of the rotors.

42. A rotary wing vehicle as claimed in claim 1 in which the control system controls the plurality of rotors to produce an arbitrary selectable or desired torque vector by varying the respective spin directions of the rotors.

43. A rotary wing vehicle as claimed in claim 1 in which the rotor planes are orthogonal or non-orthogonal.

44. A rotary wing vehicle as claimed in claim 1 in which the plurality of rotors comprises at least six rotors, in which the six rotors are operable in pairs wherein the rotors planes of the rotors in each pair are coplanar rotation planes and wherein the coplanar rotation planes of the three pairs of rotors are orthogonal.

45. A rotary wing vehicle as claimed in claim 1 further comprising a frame adapted to support locomotion on a surface and wherein the control system is arranged to operate the plurality of rotors to provide such locomotion.

46. A rotary wing vehicle as claimed in claim 1 in which the control system is adapted to operate said rotors to produce a thrust vector capable of at least acting against gravity in use.

47. A control system for a rotary wing vehicle as claimed in claim 1.
